(19) United States
(12) Patent Application Publication
(10) Pub. No.: US 2006/0252093 A1
(43) Pub. Date: Nov. 9, 2006

(54) Heterocyclic organic molecules through intramolecular formation of n-acyliminium ions

(76) Inventors: Morten Meldal, Copenhagen (DK); Thomas Eiland Nielsen, Copenhagen (DK)

Correspondence Address: KNOBBE MARTENS OLSON & BEAR LLP, 2040 MAIN STREET, FOURTEENTH FLOOR, IRVINE, CA, 92614, US

(21) Appl. No.: 10/561,803

(22) PCT Filed: Jun. 25, 2004
(86) PCT No.: PCT/DK04/00454

§ 371 Date: May 9, 2006

(30) Foreign Application Priority Data
Jun. 26, 2003 (DK) PA200300967
May 25, 2004 (DK) PA200400820

(51) Int. Cl. C40B 40/04; C40B 40/10

(52) U.S. Cl. 435/7.1; 530/328; 530/329; 530/330; 530/331

(57) ABSTRACT

The present invention relates to a method of preparing heterocyclic organic com-pounds involving intramolecular formation of an N-acyliminium ion and an in-tramolecular Pictet-Spengler reaction. The invention furthermore discloses precursor molecules useful for the method and methods of preparing these precursor mole-cules. The invention also relates to heterocyclic organic compounds prepared by the methods, libraries of such heterocyclic organic compound and methods of preparing them, as well as to various uses of the heterocyclic organic compounds.

All patent and non-patent references cited in the application are hereby incorporated by reference in their entirety.

### FIELD OF INVENTION

The present invention relates to scaffolds, such as scaffolds useful in the preparation of a combinatorial chemical library. In particular, the invention relates to precursor molecules capable of being intramolecularly transformed Into a cyclic N-acyliminium Ion, wherein said N-acyliminium Ion is capable of undergoing a Pictet-Spengler reaction. The precursor molecules thus are useful for generating heterocyclic organic compounds.

The invention furthermore relates to methods of preparing said precursor molecules, methods of preparing heterocyclic organic compounds based on the scaffolds and methods of preparing libraries of heterocyclic organic compounds. The invention furthermore relates to heterocyclic organic compounds, libraries of heterocyclic organic compounds and uses of said compounds.

### BACKGROUND OF INVENTION

One prime goal for solid-phase combinatorial synthesis is the identification and optimisation of pharmaceutical lead compounds. The high-speed generation of chemical libraries offered by solid-phase synthesis techniques may be highly efficient, since work-up and purification can be achieved by simple washing and filtration, and combinatorial chemistry is thus becoming an increasingly important tool for drug discovery. It is therefore of utmost importance that the applied reactions proceed in a clean and quantitative fashion. Today, solid-phase peptide synthesis is well-established, fulfilling this requirement with high efficiency, and to high levels of sophistication. However, in the search for new drugs, peptide isosters and mimetics Incorporating heterocyclic motifs have attracted considerable attention, and the clean transformation of short peptide strands into heterocycles have accordingly emerged as an increasingly important area of research.

Over the past hundred years, considerable interest has been given to the certain classes of heterocyclic ring-systems referred to as tetrahydroisoquinolines (THIQs) and tetrahydro-β-carbolines (THBCs), due to their presence in many naturally and synthetically derived molecules, which possess a wide range of biological properties and frequently hold promising pharmaceutical potential. For example, compounds constituted by THIQ ring structures have been reported to display antitumor and antimicrobial activity, (Scott, J. D.; Williams, R. M. Chem. Rev. 2002, 102, 1669-1730) stimulation of β₃adrenergic receptors, (Parmee, E. R.;. Brockunier, L. L.; Singh, S. B.; Candelore, M. R.; Cascieri, M. A.; Deng, L.; Liu, Y.; Tota, L.; Wyvratt, M. J.; Fisher, M. H.; Weber, A E. Biooganic Med. Chem. Left. 2000, 10, 22832286) and 5HT_{1A} receptor agonism. (Mokrosz, M. J.; Bojarski. A. J.; Duszynska, B.; Tatarczynska, E.; Klodzinska, A.; Deren-Wesolek, A.; Charakchieva-Minol, S.; Chojnacka-Wojcik, E. Bioorg. Med. Chem. 1999, 7, 287-295). When inserted in a peptide, THIQ-3-carboxylic acids may restrict the number of conformations of the α-amino acid backbone, (Gibson, S. E.; Guillo, N.; Tozer, M. J. Tetrahedron 1999, 55, 585-615.) which may be important for enhanced pharmacological properties, as illustrated in certain δ-opioid receptor antagonists. (Salvadoli, S.; Balboni, G.; Guerrini, R.; Tomatis, R.; Bianchi, C.; Bryant, S. D.; Cooper, P. S.; Lazarus, L. H. J. Med. Chem. 1997, 40, 3100-3108). THBCs exhibit significant bioactivities and pharmacological properties, particularly in the central nervous system with known interactions at benzodiazeoine (Braestrup, C.; Nielsen, M. J. Neurochem. 1981, 37, 333-341 and Braestrup, C.; Nielsen, M.; Olsen, C. E. Proc. Natl. Acad. Sci. U.S.A. 1980, 77, 2288-2292) serotonin (for the inhibition of monoamine oxidase A and binding with nanomolar affinity to serotonin receptors, see: Ho, B. T. Pharm. Sci. 1972, 61, 821-837. For other examples of binding to serotonin receptors, consult Abou-Gharbia, M.; Patel, U. R.; Moyer, J. A.; Muth, E. A. J. Med. Chem. 1987, 30, 1100-1105; Audia, J. E., Evrard, D. A.; Murdoch, G. R.; Droste, J. J.; Nissen, J. S.; Schenck, K. W.; Fludzinski, P.; Lucaltes, V. L.; Nelson, D. L.; Cohen, M. L. J. Med. Chem. 1996, 39, 2773-2780), and dopamine receptors. (Abou-Gharbia, M.; Patel, U. R.; Webb, M. B.; Moyer, J. A.; Andree, T. H.; Muth, E. A. J. Med. Chem. 1987, 30, 1818-1823) THBCs bind to the GABA_{A} receptor ion channel and may be involved in the molecular mechanisms controlling anxiety, convulsions and sleep (Ninan, P. T.; Insel, T. M.; Cohen, R. M.; Cook, J. M.; Skolnick, P.; Paul, S. M. Science 1982, 218, 1332-1334; Mendelson, W. B.; Cain, M.; Cook, J. M.; Paul, S. M.; Skolnick, P. Science 1982, 218, 414-416)

These core structures have attracted considerable attention, and effective synthetic methodology towards their formation has been developed. Since its discovery, (Pictet, A; Spengler, T. Ber. 1911, 44, 2033-2036) the Pictet-Spengler reaction has been a widely used tool for the construction of THIQs and THBCs (Cox, E. D.; Cook, J. M. Chem. Rev. 1995, 95, 1797-1842) Without the use of this powerful reaction for C—C bond formation, a number of total syntheses of highly complicated indole and isoquinoline derived alkaloids would have been difficult to achieve. To date, several solid-phase versions of the Pictet-Spengler reaction have been reported for the construction of THBCs. The typical approach comprises the Brønsted acid catalysed intermolecular condensation of an aldehyde with a solid-supported tryptophan moiety, (Kaijuste, K.; Undén, A. Tetrahedron Lett. 1995, 36, 9211-9214. Yang, L; Guo, L Tetrahedron Lett. 1996, 37, 5041-5044. Mayer, J. P.; Bankaitis-Davis, D.; Zhang, J.; Beaton, G.; Bjergarde, K.; Andersen, C. M.; Goodman, B. A.; Herrera, C. J. Tetrahedron Lett. 1996, 37, 5633-5636. Fantauzzi, P. P.; Yager, K. M. Tetrahedron Lett. 1998, 39, 1291-1294) or tryptamine derivative, (Wu, T. Y. H.; Schultz, P. G. Org. Lett. 2002, 4, 4033-4036) followed by Pictet-Spengler cyclization. Typically, further solid-phase functionalisation of THBCs involve reactions of the β-amino group with acylation reagents, such as acid halides, sulfonyl chlorides, and isocyanates. (see e.g. Mohan, R.; Chou, Y.-L.; Morrissey, M. M. Tetrahedron Lett. 1996, 37, 3963-3966) Thus, CIP activated amino acids (Loevezjin, A. v.; Maarsveen, J. H. v; Stegman, K; visser, G. M.; Koomen, G.-J. Tetrahedron Lett. 1999, 39, 4737-4740), and amino acid chlorides have been employed for the synthesis of analogues of fumitremorgin, (Wang, H.; Ganesan, A. Org. Lett. 1999, 1, 1647-1649) and chloroformates towards tetrahydro-β-carbolinehydantoins. (Bonnet, D.; Ganesan, A. J. Comb. Chem. 2002, 4, 546-548. When the aldehyde part of the Pictet-Spengler reaction contains a latent amino functionality, the THBC core may also be incorporated between peptide strands, ideally to introduce conformational constraints to the peptide structure. (Li, X.; Zhang, L.; Zhang. W.; Hall, S. E.; Tam. J. P. Org. Lett. 2000, 2, 3075-3078.) Fewer reports have dealt with the solid-phase synthesis of THIQs. For this purpose, the Bischler-Napieralsky reaction has been exploited, but the method seems limited by harsh reaction conditions (POCl₃, acid, elevated temperatures) and moderate yields. (Meutermanns, W. D. F.; Alewood, P. F. Tetrahedron Lett. 1995, 36, 7709-7712. Rolfing, K.; Thiel, M.; Kunzer, H. Synlett 1996, 1036-1037.) On the other hand, Pictet-Spengler reactions of electron-rich phenylethylamine derivatives have proven highly successful (for the first example on solid-phase Pictet-Spengler reactions towards THIQs, and extensions into tetrahydroimidazopyridines, consult Hutchins, S. M.; Chapman, K. T. Tetrahedron Lett. 1986, 37, 4865-4868. See also: Sun, Q.; Kyle, D. J. Combinatorial Chemistry & High Throughput Screening 2002, 5, 7581, and Myers, A. G.; Lanman, B. A. J. Am. Chem. Soc. 2002, 124, 12969-12971, for recent applications) Generally, the formation of a new C—C bond via these processes generates a stereogenic centre of which the stereoisomeric purity is reflected by the ratio of the intermediate cisoid and transoid iminium ion species. Thus, Pictet-Spengler reactions based on intermolecular condensation reactions generally lead to formation of several stereoisomers.

As opposed to precedent solid-phase Pictet-Spengler reactions, our research group has reported the intermolecular condensation of a solid-supported aldehydes with tryptophan, tryptamine, and histidine derivatives (Groth, T.; Meldal, M. J. Comb. Chem. 2001, 3, 45-63). Simultaneously, we reported a highly efficient approach for solid-phase generation of aldehydes from masked aldehyde building blocks protected as their NV-Boc N,O-acetals. (Groth, T.; Meldal, M. J. Comb. Chem. 2001, 3, 34-44.) In order to conduct intermolecular synthetic transformations of aldehyde moieties attached to solid-supported peptides or peptide isosters, we noted the necessity of N-protection of the amide backbone to prevent undesired condensation reactions of amide-nitrogens with the aldehyde.

### SUMMARY OF THE INVENTION

Interestingly, the present application discloses that intramolecular condensation reactions may be used to generate a cyclic (and thus stereoisomeric pure) N-acyliminium ion, which may serve as a highly reactive key intermediate for for example solid-phase synthesis of heterocyclic scaffolds. Thus in one aspect, the Invention discloses solid-phase chemistry based on intramolecular condensation of an aldehyde with an amide nitrogen, where the generated N-acyliminium Ion may be trapped with carbon nucleophiles (for a general review regarding cyclization of carbon nucleophiles to N-acyliminium ions, consult: Maryanoff, B. E.; Zhang, H.-C.; Cohen, J. H.; Turchi, I. J.; Maryanoff, C. A. Chem. Rev. 2004, 104, 1431-1628). The reaction products can be characterized as multicyclic lactams.

The present invention teaches that following such solid-phase route to a cyclic N-acyliminium ion, for example a quantitative and highly stereoselective Pictet-Spengler reaction or another cationic cyclisation reaction may be brought about provided the presence of a neighboring nucleophillic group, such as an indole of a neighboring tryptophan, thereby appending two new N-fused rings to the indole moiety. Feasible structures are, for example, the 3-oxohexahydroindolizino[8,7-b]indole-5-carboxylate derivatives, which have been proposed as mimics of β-turns, (Figuera, N. D. I.; Alkorta, I.; Garcia-López, M. T.; Herranz, R.; González-Muñiz, R. Tetrahedron 1995, 51, 7841-7856.) and demonstrated to be potent and selective CCK1 receptor antagonists when attached to peptides. (Martin-Martinez, M.; Figuera, N. D. I.; Latorre, M.; Herranz, R.; Garcia-Lopez, M. T.; Cenarruzabeitia, E.; Rio, J. D.; González-Muñiz, R. J. Med. Chem. 2000, 43, 3770-3777. Solid-phase synthesis incorporating the 3-oxohexahydroindolizino[8,7-b]indole-5-carboxyl core within peptide strands has also been reported. (Grimes, J. H.; Angell, Y. M.; Kohn, W. D. Tetrahedron Lett. 2003, 44, 3835-3838.) Surprisingly, the present invention teaches that extension of this domino reaction to substituted indoles and other nucleophiles, such as other reactive heterocycles known to react in Pictet-Spengler condensation reactions, such as furanes, (Miles, W. H.; Heinsohn, S. K.; Brennan, M. K.; Swarr, D. T.; Eidam, P. M.; Gelato, K. A. Synthesis 2002, 1541-1545, and references herein) and thiophenes, (consult for example: Othman, M.; Pigeon, P.; Decroix, B. Tetrahedron 1997, 53, 2495-2504), and electron-rich aromatic rings, provides a mild, efficient and rapid access to a range of pharmacologically interesting tri- and tetracyclic scaffolds or even scaffolds comprising more fused rings.

Hence, the present invention offers the possibility to prepare heterocyclic organic compounds on solid phase, wherein the sterochemistry can be controlled and heterocyclic organic compounds can be obtained as pure stereoisomers. It is of great advantage to prepare such compounds on solid phase, because it enables quick and fast recovery of the compounds. Furthermore, undesired cross-reactions are significantly reduced or totally avoided by performing intramolecular condensation on solid phase.

The site isolation on each molecule is achieved by its attachment to the 3-dimensional polymer network, such as a resin bead, that practically confer infinite size to each molecular entity. This has the effect that the molecule reacts much more slowly in a bimolecular reaction than the same molecule would do off bead in solution. Some reactions that may be carried out in solution with an acceptable-yield simply will not perform on solid support. Therefore, on solid phase reactions are usually selected that are essentially quantitative, and free of side reactions that can compete in the solution phase This relation is reversed when a intramolecular reaction is considered. Here the reaction on the solid support is just as fast as in solution and competing bimolecular side reactions are still slow compared to solution reactions. Therefore a very clean and selective transformation may be obtained on solid support. The performance of a key reaction of this invention i. e. the intermediate formation of intramolecular N-acyliminium ions from an amide and an aldehyde and their condensation with a nucleophile is therefore quite selective and unique.

It is thus one objective of the present invention to provide a precursor molecule of the formula
[MABB-(AA)ₙ-NuBB], wherein
MABB is a masked aldehyde building block of the formula:
   [MA-L₁-AG-], wherein
   MA is a masked aldehyde,
   L₁ is an aryl ring or alkyl chain comprising x covalently linked atoms selected from the group consisting of C, N, O and S, wherein x is an integer in the range of 0 to 10, and wherein said aryl ring or alkyl chain may be substituted independently on each position, and wherein the atom most proximal to the CO group is a carbon atom,
   AG is an acidic group capable of forming an amide bond,
AA is an amino acid of the formula —NHCR¹R²CO— and n is an integer in the range of 0 to 5,
NuBB is a nucleophile building block of the formula
   [—NH-L₂-Nu-], wherein
   —NH is an amino group forming an amide with AA or when n is 0 with AG,
   L₂ is an alkyl comprising in the range of 1 to 4 covalently linked atoms selected from the group consisting of C, N, O and S, wherein each atom may be independently substituted,
   Nu is a nucleophilic chemical entity comprising a π system,
wherein NuBB is linked to (AA)ₙ or if n=0 to MABB via an amide bond and with the proviso, that when x=0, then n is at least 1,
and wherein the masked aldehyde may be transformed into a free aldehyde, and the free aldehyde group is capable of interacting intramolecularly with an amide group, thereby forming an M-acyliminium ion,
and wherein said M-acyliminium ion is capable of acting as an electrophile for intramolecular reaction with said nucleophilic chemical entity,

Such a precursor molecule is in particular useful as a precursor for intramolecular condensation.

It is a second objective of the present invention to provide methods of preparing said precursor molecule, comprising the steps of
a) Providing a masked aldehyde building block (MABB) of the formula:
   [MA-L₁-AG₂], wherein
   MA is a masked aldehyde protected by an aldehyde protecting group,
   L₁ is an aryl or alkyl comprising x covalently linked atoms selected from the group consisting of C, N. S and O that may be substituted independently on each position, wherein x is an integer in the range of 1 to 10 wherein the atom most proximal to the CO group is a carbon atom,
   AG₂ is an acidic group capable of reacting with an amino group to form an amide,
ii) Providing a molecule of the structure [-(AA)ₙ-NuBB], wherein
   AA is an amino acid and n is an integer in the range of 0 to 5,
   NuBB is a nucleophile building block of the formula
      [—NH-L₂-Nu-], wherein
   —NH— is the amino group of an amide, preferably —NH— is a secondary amino group, preferably an amino group forming an amide with AA or when n is 0 —NH— is an —NH₂ group capable of forming an amide with AG₂,
   L₂ is an alkyl comprising in the range of 1 to 4 covalently linked atoms selected from the group consisting of C, N, O and S, wherein each atom may be independently substituted,
   Nu is a nucleophilic chemical entity comprising a π system,
   wherein (AA)ₙ is linked to NuBB via an amide bond
iii) Reacting said MABB with said molecule, thereby forming an amide bond between said MABB and said molecule
iv) Thereby obtaining a precursor molecule.

It is a third objective of the present invention to provide methods of preparing a heterocyclic organic compound comprising at least 2 fused rings designated A and B, wherein ring A incorporates a carbonyl group and ring A and B share at least one N atom, said method comprising the steps of
a) Providing a precursor molecule as described by the present invention
b) Transforming the masked aldehyde into a free aldehyde
c) Reacting said free aldehyde with an amide group within said precursor molecule, thereby obtaining an N-acyliminium ion, wherein said N-acyliminium ion is capable of acting as an electrophile
d) Performing an intramolecular nucleophilic reaction involving the N-acyliminium ion and the nucleophilic chemical entity forming a new covalent bond, thereby obtaining said cyclic organic compound.

It is a further objective of the present invention to provide compounds prepared by the method according to the invention, wherein said compound is a heterocyclic compound comprising at least 2 fused rings designated A and B, wherein ring A incorporates a carbonyl group and ring A and B shares at least one N atom, wherein said compound comprises or consists of
i) a 7,5, or a 7,6-bicyclic scaffold, or,
ii) a 5,5,5, a 5,6,5-, a 5,5,8-, or a 5,6,8-tricyclic scaffold, or,
iii) a 6,5,5-, a 6,6,5-, a 6,5,8-, or a 6,6,8-tricyclic scaffold, or,
iv) a 6,5,5,5-, a 6,5,6,5-, a 6,5,5,8-, a 6,5,6,8-tetracyclic scaffold, or,
v) extensions of any of the scaffolds mentioned in a) to d) comprising at least one further ring fused to said scaffold,
   wherein each of said scaffolds may be independently substituted on every position,
   and wherein said compound is covalently attached to a solid support.

It is a still further objective of the present invention to provide methods of preparing a library comprising at least 2 different cyclic organic compounds each comprising at least 2 fused rings designated A and B, wherein ring A is substituted with a carbonyl group and ring A and B shares at least one N atom, said method comprising the steps of
a) Providing at least 2 different precursor molecules according to the invention
b) performing the method of preparing a heterocyclic compound for each of said precursor molecules
   i) thereby obtaining a library comprising at least 2 different cyclic organic compounds.

It is an even further objective of the present invention to provide a library of heterocyclic compounds prepared by said method.

It is another objective of the present invention to provide methods of identifying a heterocyclic organic compound capable of associating with a cell surface molecule naturally expressed on the surface of a cell, said method comprising the steps of
ii) Providing the library of heterocyclic compounds described by the invention,
iii) Providing a composition comprising said cell surface molecule,
iv) Incubating said library with said composition
v) Identifying heterocyclic compounds of said library capable of specifically associating with said cell surface molecule.

It is also an objective of the present invention to provide use of a heterocyclic organic compound identified according to said identification method for the preparation of a medicament for the treatment of a clinical condition in an individual in need thereof.

It is a still further objective of the present invention to provide use of a heterocyclic organic compound identified according to said identification method for affinity chromatography.

It is even a further objective of the present invention to provide use of a heterocyclic organic compound identified according to said identification method for affinity labelling.

### DESCRIPTION OF DRAWINGS

FIG. 1 illustrates synthetic use of the intramolecular aldehyde-amide N condensation

FIG. 2 illustrates acidic reation conditions useful for aldehyde unmasking/intramolecular N-acyliminium Pictet-Spengler reaction

FIG. 3 illustrates HPLC analysis of an example of a precursor molecule (I) and the corresponding product (II) resulting from solid-phase intramolecular N-acyliminium Pictet-Spengler reaction

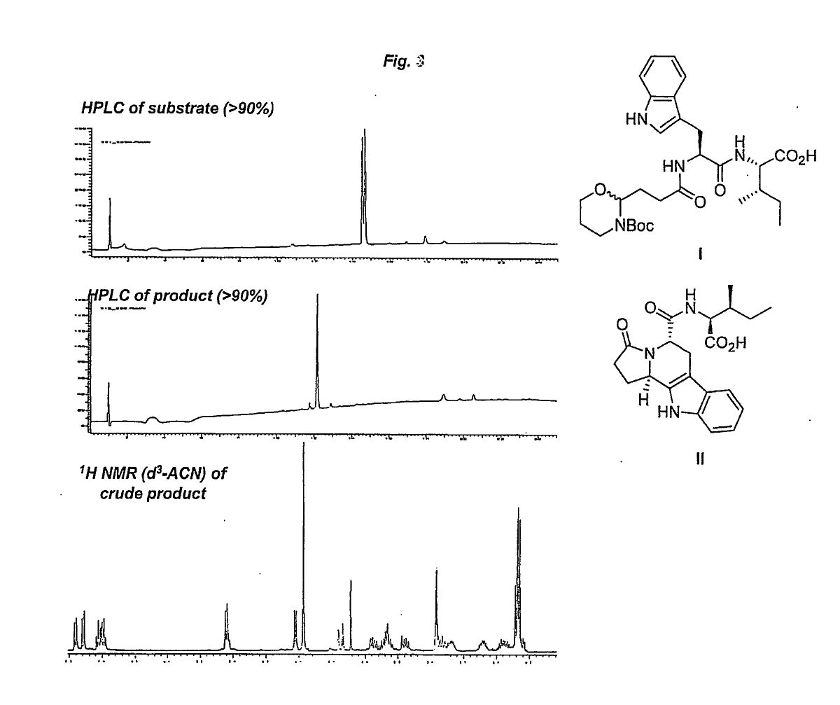

FIG. 4 illustrates an example of preparation of substrates (or precursor molecules) for solid phase intramolecular N-acyliminium Pictet-Spengler reactions via standard peptide synthesis procedures

FIG. 5 illustrates an example of extension of the solid-phase intramolecular N-acyliminium Pictet-Spengler methodology to the formation of larger ring systems by inserting N-protected AA(s) between MABB and Trp. In the example, Trp is the nucleophile building block.

FIG. 6 illustrates possible precursor molecules for solid phase N-acyliminium Pictet-Spengler and the corresponding products. Examples of potential reactive aromatic side chain (substituted tryptophans and other aromatic side chains) are shown.

FIG. 7 illustrates an alcohol demasking/oxidation approach towards aldehydes capable of undergoing intramolecular N-acyliminium Pictet-Spengler reactions

FIG. 8 illustrates applications of amino-functionalised MABB, wherein the masked aldehyde is an alcohol. The figure shows a solid-phase oxidation approach using commercially available MABB, wherein the masked aldehyde is an alcohol.

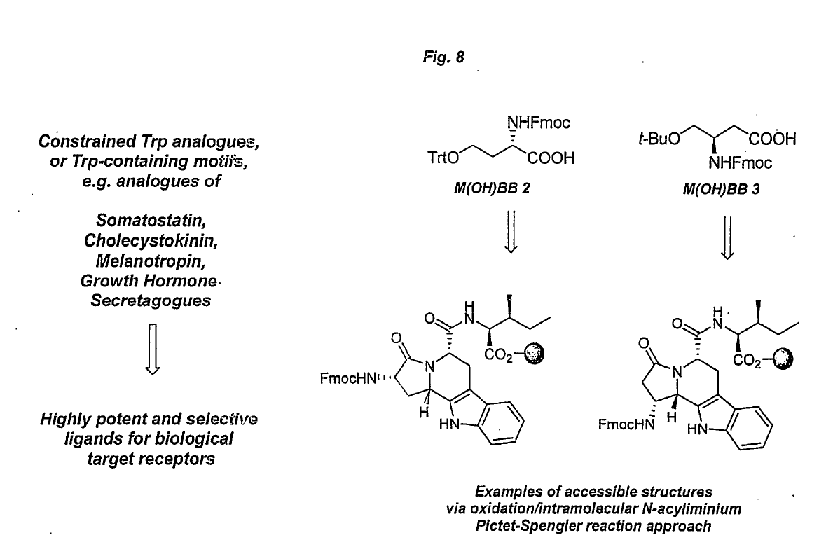

FIG. 9 illustrates representative analytical HPLCs for intramolecular N-acyliminium Pictet-Spengler reation substrates 1

FIG. 10 illustrates representative analytical HPLCs for intramolecular N-acyliminium Pictet-Spengler reation substrates 2

FIG. 11 illustrates representative analytical HPLCs for intramolecular N-acyliminium Pictet-Spengler reation substrates 3

FIG. 12 illustrates representative analytical HPLCs for intramolecular N-acyliminium Pictet-Spengler reation products 1

FIG. 13 illustrates representative analytical HPLCs for intramolecular N-acyliminium Pictet-Spengler reation products 2

FIG. 14 illustrates representative analytical HPLCs for intramolecular N-acyliminium Pictet-Spengler reation products 3

### DEFINITIONS

Masked aldehyde: A masked aldehyde according to the present invention is a chemical entity, wherein said chemical entity may be transformed to an aldehyde. In particular, the masked aldehyde may comprise an aldehyde protecting group, which may be removed chemically, thereby generating a free aldehyde. Alternatively the masked aldehyde may comprise a group that can be transformed into an aldehyde, for example an alcohol, an ester, an alkene, a diol, or a thiolester. A masked aldehyde may furthermore comprise a chemical group that can be transformed into an aldehyde, wherein said chemical group furthermore is protected by a protecting group.

### DETAILED DESCRIPTION OF THE INVENTION

Precursor Molecule

In one aspect the present invention relates to a precursor molecule of the formula
[MABB-(AA)ₙ-NuBB], wherein
MABB is a masked aldehyde building block of the formula:
   [MA-L₁-CO—], wherein
   MA is a masked aldehyde,
   L₁ is an aryl ring or alkyl chain comprising x covalently linked atoms selected from the group consisting of C, N, O and S, wherein x is an integer in the range of 0 to 10, and wherein said aryl ring or alkyl chain may be substituted independently on each position, and wherein the atom most proximal to the CO group is a carbon atom,
   CO is a carbonyl group,
AA is an amino acid of the formula —NHCR¹R²CO— and n is an integer in the range of 0 to 5,
NuBB is a nucleophile building block of the formula
   [—NH-L₂Nu-], wherein
   —NH is a secondary amino group, preferably an amino group forming an amide with AA or when n is 0 with AG,
   L₂ is an alkyl comprising in the range of 1 to 4 covalently linked atoms selected from the group consisting of C, N, O and S, wherein each atom may be independently substituted,
   Nu is a nucleophilic chemical entity comprising a r system,
wherein NuBB is linked to (M)ₙ or if n=0 to MABB via an amide bond and with the proviso, that when x=0, then n is at least 1,
and wherein the masked aldehyde may be transformed into a free aldehyde, and the free aldehyde group is capable of interacting with an intramolecular amide group, thereby forming an N-acyliminium ion,
and wherein said N-acyliminium ion is capable of acting as an electrophile for intramolecular reaction with said nucleophilic chemical entity,

The masked aldehyde building block, the amino acids and the Nucleophile building block may be any of the masked aldehyde building block, the amino acids and the Nucleophile building block described herein below, respectively.

In one preferred embodiment of the present invention the precursor molecule is covalently attached to a solid support. The solid support may be any of the solid supports mentioned herein below.

In particular, different precursor molecules according to the present invention may be derived from the same scaffold, by differentially substituting said scaffold on one or more positions.

In one embodiment of the present invention the precursor molecule may be selected from the group consisting of the structures illustrated herein below and derivatives thereof, wherein each of the structures may be substituted independently on every position with one or more selected from the group consisting of H, hydroxy, alkoxy, aryloxy, acyloxy, thiol, alkylthio, arylthio, heteroarylthio, sulphonyl, sulphoxy, amino, alkylamino, dialkylamino, acylamino, diacylamino, alkoxycarbonylamino, amides, alkyl, branched alkyl, aryl, heteroaryl, nitro, cyano, halogeno, silyloxy, keto, heterocycles, fused ring systems, fused heterocycles and mixtures thereof, wherein each of the aforementioned may be substituted with one or more groups selected from the group consisting of —H, —OH, —SH, halogen, carboxyl, carbonyl, alkoxy, aryloxy, acyloxy, alkylthio, arylthio, heteroarylthio, sulphonyl, sulphoxy, amino, alkylamino, dialkylamino, acylamino, diacylamino, alkoxycarbonylamino, amides, alkyl, aryl, heteroaryl, nitro, cyano, halogeno, silyloxy, keto, heterocycles, fused ring systems, and fused heterocycles.

Examples of precursor molecules according to the invention include any of the structures illustrated below, as well as any of said structures substituted with one or more of the above-mentioned groups and derivatives thereof as well as stereoisomers thereof. In addition, the precursor molecules may be any of said structures and derivatives thereof, wherein said precursor molecules are not attached to a solid support. Further examples of precursor molecules according to the invention are any of the precursor molecules given in example 2 as well as any of said precursor molecules substituted with one or more of the above-mentioned groups and derivatives thereof as well as stereoisomers thereof. Preferred precursor molecules include the specific precursor molecules illustrated below and in example 2.

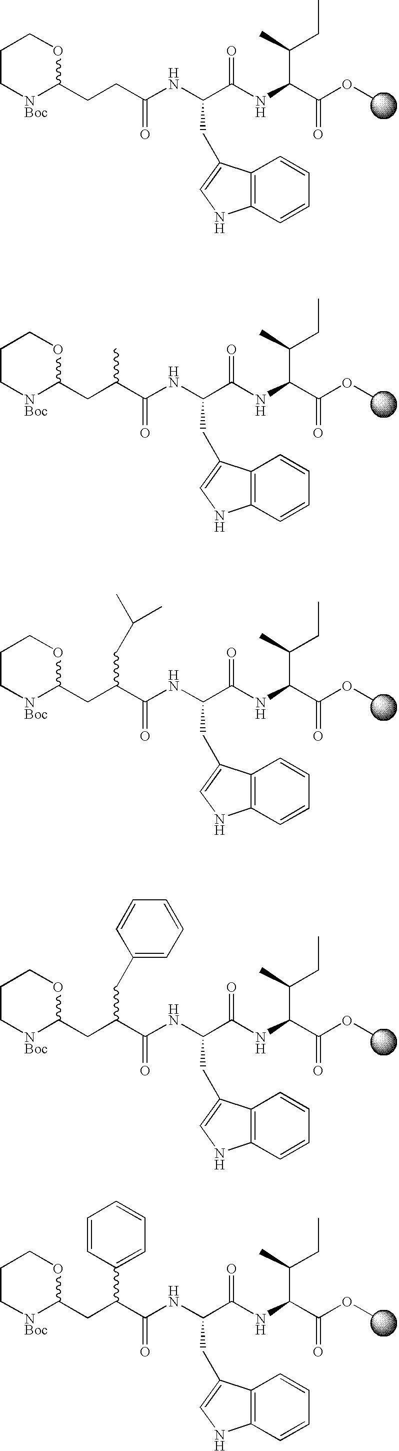

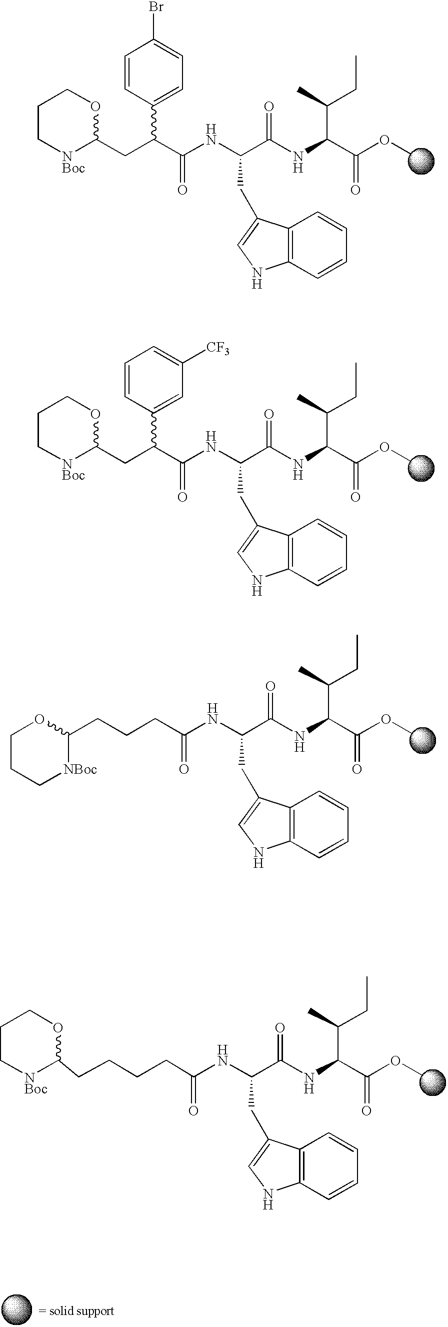

The precursor molecules of the present invention are useful for intramolecular condensation leading to formation of heterocyclic organic compounds. In general, the stereochemistry of the nucleophile building block of the precursor molecule determines the absolute configuration of the newly generated stereocenter of the heterocyclic organic compound. By way of example, if the nucleophile chemical entity is a nucleophilic side chain of an amino acid, then if that amino acid is in the S-form, then the newly generated sterocenter of the heterocyclic organic compound will be the R-isomer. If that amino acid is in the R-form, the newly generated stereocenter of the heterocyclic organic compound will be the S-Isomer. A person skilled in the art, will be able to select a nucleophile building block with a suitable stereochemistry in order to obtain a heterocyclic organic compound of the desired stereochemistry.

Nucleophile Building Block

The nucleophile building block according to the present Invention comprises a nucleophilic chemical entity.

The nucleophilic chemical entity should be capable of participating in a Pictet-Spengler reaction, or another cyclization process involving electronrich double or triple bonds forming a new covalent bond, thereby forming a heterocyclic organic compound comprising at least 2 fused rings designated A and B, wherein ring A incorporates a carbonyl group and ring A and B shares at least one N atom. Said covalent bond is preferably selected from the group consisting of C—C, C—N, C—S, and C—O, more preferably it is a C—C bond. When the nucleophilic chemical entity comprises a X system, then the covalent bond will in general be a C—C bond.

The nucleophile chemical entity may comprise one or more electron donating groups, and/or one or more nucleophilic heteroatoms. Preferably, the electron donating groups and/or the nucleophilic heteroatoms is selected from the group consisting of hydroxy, alkoxy, aryloxy, acyloxy, thiol, alkylthio, arylthio, heteroarylthio, sulphonyl, sulphoxy, amino, alkylamino, dialkylamino, acylamino, diacylamino, alkoxycarbonylamino, mono-, di-, and trisubstituted aromatic and heteroaromatic rings, alkenes, alkynes and combinations thereof.

More preferably, the nucleophile chemical entity comprises or consists of an electron donating group selected from the group consisting of mono-, di-, and trisubstituted aromatic and heteroaromatic rings, alkenes and alkynes, wherein each of the aforementioned may be substituted with one or more selected from the group consisting of hydroxy, alkoxy, aryloxy, acyloxy, thiol, alkylthio, arylthio, heteroarylthio, sulphonyl, sulphoxy, amino, alkylamino, dialkylamino, acylamino, diacylamino, alkoxycarbonylamino.

More preferably, the nucleophilic chemical entity is selected from the group consisting of chemical entities comprising a functional group selected from the group consisting of —NHR, —NH₂, Alkyl-SH, Aryl-SH, Alkyl-OH, Aryl-OH, mono-, di-, and trisubstituted aromatic and heteroaromatic rings, alkenes and alkynes

Said aromatic or heteroaromatic ring may be selected from the group consisting of arenes, benzothiophene, benzofuran, isoindoles, 1,3-azole, imidazole, thiazole, oxazole, 1,2-azole, pyrazole, isothiazole, isoxazole, isoxazoline, purine, indolizine, quinolizine, pyrrolizine, 1,2,3-triazole, 1,2,4-triazole, pyridine, quinoline, quinoline, Isoquinoline, pyridazine, pyrimidine, pyrazine, pyrrole, indole, thiophene and furane, such as from the group consisting of arenes, pyrroles, indoles, thiophenes, and furanes.

The aromatic ring or the alkenes may be substituted independently on every position, for example the aromatic ring or the alkenes may be substituted by one or more selected from the group consisting of substituents comprising or consisting of H, hydroxy, alkoxy, aryloxy, acyloxy, thiol, alkylthio, arylthio, heteroarylthio, sulphonyl, sulphoxy, amino, alkylamino, dialkylamino, acylamino, diacylamino, alkoxycarbonylamino, alkyl, branched alkyl, aryl, heteroaryl, nitro, cyano, halogeno, and silyloxy.

Thus, the nucleophilic chemical entity may be a nucleophilic chemical entity comprising a π system comprising an N, O or S atom or a chemical entity which is substituted with an N, O or S atom.

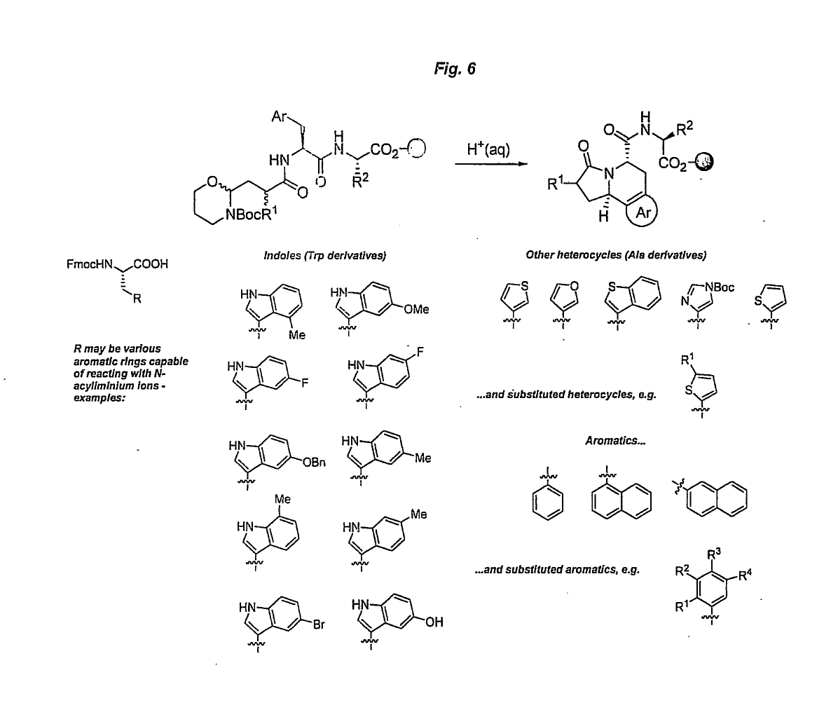

Non limiting examples of suitable nucleohilic chemical entities are given in FIG. 6.

In one embodiment of the invention, the nuclephilic chemical entity is an indole or an indole substituted with one or more of the above-mentioned groups or a derivative thereof. It is thus preferred in this embodiment that the nucleophile building block comprises or even consists of a tryptophan, a substituted tryptophan or a derivative thereof. Non-limiting examples of suitable indoles and indole derivatives are given in FIG. 6.

The nucleophile building block comprises a linker designated L₂, linking the secondary amino/amido group and the nucleophilic chemical entity. L₂ may be any suitable linker capable of linking the secondary amino group and the nucleophilic chemical entity, for example L₂ may be an alkyl, preferably a linear alkyl comprising in the range of 1 to 4, preferably in the range of 1 to 3 covalently linked atoms selected from the group consisting of C, N, O and S, wherein each atom may be independently substituted.

In one embodiment of the invention L₂ has the structure 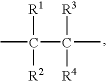
wherein R¹, R², R³ and R⁴ independently may be selected from the group consisting of H, hydroxy, alkoxy, aryloxy, acyloxy, thiol, alkylthio, arylthio, heteroarylthio, sulphonyl, sulphoxy, amino, alkylamino, dialkylamino, acylamino, diacylamino, alkoxycarbonylamino, amides, alkyl, branched alkyl, aryl, heteroaryl, nitro, cyano, halogeno, silyloxy, keto, heterocycles, fused ring systems, fused heterocycles and mixtures thereof, wherein each of the aforementioned may be substituted with one or more groups selected from the group consisting of —H, —OH, —SH, halogen, carboxyl, carbonyl, alkoxy, aryloxy, acyloxy, alkylthio, arylthio, heteroarylthio, sulphonyl, sulphoxy, amino, alkylamino, dialkylamino, acylamino, diacylamino, alkoxycarbonylamino, alkyl, branched alkyl, aryl, heteroaryl, nitro, cyano, halogeno, silyloxy, keto, heterocycles, fused ring systems, and fused heterocycles. The alkyl may be selected from the group consisting of linear alkyl, branched alkyl and cyclic alkyls.

In a preferred embodiment, R², R³ and R⁴ are —H, and R¹ is selected from the group consisting of amides and peptides, optionally substituted with one or more groups. Said peptide may consist of any amino acids, however in a preferred embodiment the peptides consist of naturally occuring amino acids.

It is preferred that the NuBB is covalently linked to a solid support, The solid support may be any of the solid supports described herein below. Preferably, the NuBB is linked to the solid support via a linker designated L₃, which Is covalently linked to L₂, L₃ preferably comprises a bulky group. In particular, when it is desirable to control the stereochemistry of the resulting heteroaromatic organic compound, it is preferred that L₃ comnprises a bulky group. Preferably, said bulky group is selected from the group consisting of carbonyl, esters and amids. More preferably, the bulky group is carbonyl. In a preferred embodiment L₃ is a peptide or peptidomimetic, more preferably a peptide. Hence, in one embodiment of the invention R², R³ and R⁴ are —H, and R¹ is selected from the group consisting of amides and peptides, wherein said amide or peptide is covalently linked to a solid support via a cabonyl group.

Masked Aldehyde Building Block

The masked aldehyde building block according to the present invention comprises a masked aldehyde. By masked aldehyde is meant a chemical entity, which may be transformed into an aldehyde by one or more chemical reactions, preferably the masked aldehyde may be transformed into an aldehyde by at the most 5, more preferably at the most 4, even more preferably at the most 3, yet more preferably at the most 2 chemical reactions, and most preferably a single chemical reaction.

It is preferred that the masked aldehyde Is a molecular entity of the formula:

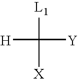

wherein the central atom is C; and

X and Y independently may be selected from the group consisting of:

OH, OAlkyl, OAryl, OHeteroaryl, SAlkyl, SAryl, SHeteroaryl, N(PG)Alkyl, N(PG)Aryl, N(PG)Heteroaryl,

wherein PG is a carbamate, preferably a methyl or ethyl carbamate, substituted methyl carbamate (preferably Fmoc, substituted fluorenylmethyl carbamates, Bimoc) or ethyl carbamate (preferably Troc, Teoc, Boc, Adoc, Alloc), benzylcarbamate (Cbz), substituted benzylcarbamate, substituted aryl- and heteroaryl carbamate or PG is a formyl, acetyl, substituted acetyl, benzyl, allyl or trialkylsilyl.

L₁ is a linker linking the masked aldehyde with a carbonyl group, the structure of L₁ is defined herein above.

Included are cyclic structures with X and Y as part of the same ring:

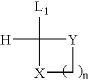

Where n can be any integer, for example n may be 0, such as 1, for example 2, such as 3, for example 4, such as 5, for example larger than 5.

In one preferred embodiment of the invention the masked aldehyde is an aldehyde protected by an aldehyde protecting group.

An aldehyde protecting group is a chemical entity that may be removed from a compound in one chemical reaction, thereby liberating a free aldehyde. For example the aldehyde protecting group may be removed by acid treatment, alkaline treatment, fluoridolysis or hydrogenolysis.

In one embodiment of the invention the aldehyde protecting group may be removed by treatment with acid. The acid may be selected from the group consisting of Brønsted acids and Lewis acids. The Brønsted acid may for example be selected from the group consisting of acetic acid, formic acid, CSA, PTSA, TFA, TCA, HCl and mono- or dichloroacetic acid.

The aldehyde protecting group may for example be selected from the group consisting of N-Boc N,O-acetals, di-Boc N,N-acetals, N-Boc N,S-acetals, N—F-moc N,O-acetals, di-F-moc N,N-acetals, N—F-moc N,S-acetals, of N-triakylsilyl N,O-acetals, di-triakylsilyl N,N-acetals, N-triakylsilyl N,S-acetals, di-O-acetals, di-S-acetals and S,O-acetals, such as from the group consisting of N-Boc N,O-acetals, di-Boc N,N-acetals, N-Boc N,S-acetals, di-O-acetals, di-S-acetals, S,O-acetals, F-moc and triakylsilyl. Preferrede aldehydeprotecting groups include for example N-Boc.

Thus, in one preferred embodiment of the invention the masked aldehyde has the structure

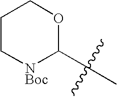

Hence, in one embodiment of the Invention the free aldehyde is generated by acid-mediated cleavage of acetals, for example as described by Vojkovský, T.; Weichsel, A.; Pátek, M. J. Org. Chem. 1998, 63, 1362-3163 or by acid-mediated cleavaged of hemiacetals for example as described by Geyer, A.; Moser, F. Eur. J. Org. Chem. 2000, 1113-1120) or by Rh-catalysed cyclohydrocarbonylation of olefins as for example described by Mizutani, N.; Chiou, W.-H.; Ojima. I. Org. Lett. 2002, 4, 4575-4578.

In another embodiment of the invention the masked aldehyde has the formula —CO—X, wherein X is not —H. Preferably, X is selected from the group consisting of alkoxy, alkylthio and alkylamino. Hence, the masked aldehyde may be selected from the group consisting of esters, thiolesters, amides and Weinreb-amides.

In yet another embodiment of the present invention, the masked aldehyde is an alcohol, wherein said alcohol may be either a free alcohol or an alcohol protected by an alcohol protecting group. Said alcohol may be transformed into an aldehyde by an oxidation reaction.

An alcohol protecting group is 2 chemical entity that may be removed in one chemical reaction, thereby forming a free alcohol. Preferably, said alcohol may be deprotected by treatment with acid, base, fluoridolysis or hydrogenolysis. For example the alcohol protecting group may be removed by treatment with acid. The acid may be selected from the group consisting of Brønsted acids and Lewis acids. The Brønsted acid may for example be selected from the group consisting of acetic acid, formic acid, CSA, PTSA, TFA, TCA, HCl and mono- or dichloroacetic acid.

The alcohol protecting group may for example be selected from the group consisting of common silyl protecting groups, alkyl protecting groups, acyl protecting groups and chlororacetyl protecting groups. The silyl protecting group may for example be selected from the group consisting of TBDMS, TBDPS, TIPS, TES and TMS, The alkyl protecting group or ether may for example selected from the group consisting of Bzl, tBu, Trt, MOM, MEM, BOM, Bn and mono- or polysubstituted benzylethers. The acyl protecting group may for example be selected from the group consisting of Acetyl, substituted acetyl and benzoyl.

The masked aldehyde building block further comprises a linker designated L₁, wherein said linker links the masked aldehyde and the carbonyl group of said masked aldehyde building block.

The linker may be any chemical entity, such as an aryl or alkyl, capable of linking the masked aldehyde and the carbonyl group, with the proviso that the atom most proximal to the carbonyl is a Carbon.

Preferably, L₁ is an aryl ring or alkyl comprising x covalently linked atoms selected from the group consisting of C, N, O and S, wherein x is an integer in the range of 0 to 10, and wherein said aryl ring or alkyl chain may be substituted independently on each position, and wherein the atom most proximal to the CO group is a carbon atom. The alkyl may be selected from the group consisting of linear alkyls, branched alkyls and cyclic alkyls.

In one preferred embodiment of the invention, L₁ is a linear alkyl chain, wherein said linear alkyl chain comprises in the range of 1 to 8, more preferably in the range of 1 to 6, even more preferably in the range of 1 to 4 atoms, i.e. x is preferably an integer in the range of 1 to 8, more preferably in the range of 1 to 6, even more preferably in the range of 1 to 4. Said linear alkyl may be substituted independently on every position with one or more selected from the group consisting of H, hydroxy, alkoxy, aryloxy, acyloxy, thiol, alkylthio, arylthio, heteroarylthio, sulphonyl, sulphoxy, amino, alkylamino, dialkylamino, acylamino, diacylamino, alkoxycarbonylamino, amides, alkyl, branched alkyl, aryl, heteroaryl, nitro, cyano, halogeno, silyloxy, keto, heterocycles, fused ring systems, fused heterocycles and mixtures thereof, wherein each of the aforementioned may be substituted with one or more groups selected from the group consisting of —H, —OH, —SH, halogen, carboxyl, carbonyl, alkoxy, aryloxy, acyloxy, alkylthio, arylthio, heteroarylthio, sulphonyl, sulphoxy, amino, alkylamino, dialkylamino, acylamino, diacylamino, alkoxycarbonylamino, amides, alkyl, aryl, heteroaryl, nitro, cyano, halogeno, silyloxy, keto, heterocycles, fused ring systems, and fused heterocycles.

In one embodiment of the invention x is 2. Hence, L₁ may have the structure 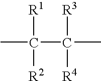
wherein R¹, R², R³ and R⁴ independently may be selected from the group of functionalities consisting of H, hydroxy, alkoxy, aryloxy, acyloxy, thiol, alkylthio, arylthio, heteroarylthio, sulphonyl, sulphoxy, amino, alkylamino, dialkylamino, acylamino, diacylamino, alkoxycarbonylamino, amides, alkyl, branched alkyl, aryl, heteroaryl, nitro, cyano, halogeno, silyloxy, keto, heterocycles, fused ring systems, fused heterocycles and mixtures thereof, wherein each of the aforementioned may be substituted with one or more groups selected from the group consisting of —H, —H, —SH, halogen, carboxyl, carbonyl, alkoxy, aryloxy, acyloxy, alkylthio, arylthio, heteroarylthio, sulphonyl, sulphoxy, amino, alkylamino, dialkylamino, acylamino, diacylamino, alkoxycarbonylamino, amides, alkyl, aryl, heteroaryl, nitro, cyano, halogeno, silyloxy, keto, heterocycles, fused ring systems, and fused heterocycles.

Preferably, R1 and R2 independently are selected from the group consisting of —H, alkyl phenyl, aryl phenyl substituted with halogen or halomethyl, alkoxy acyl amino, amino and alkyls. The alkyl is selected from the group consisting of linear alkyl, branched alkyl and cyclic alkyls.

In another embodiment of the present invention x is 3. Hence, L₁ may have the structure 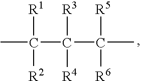
wherein R¹, R², R³, R⁴, R⁵ and R⁶ independently may be selected from the group consisting of H, hydroxy, alkoxy, aryloxy, acyloxy, thiol, alkylthio, arylthio, heteroarylthio, sulphonyl, sulphoxy, amino, alkylamino, dialkylamino, acylamino, diacylamino, alkoxycarbonylamino, amides, alkyl, branched alkyl, aryl, heteroaryl, nitro, cyano, halogeno, silyloxy, keto, heterocycles, fused ring systems, fused heterocycles and mixtures thereof, wherein each of the aforementioned may be substituted with one or more groups selected from the group consisting of —H, —OH, —SH, halogen, carboxyl, carbonyl, alkoxy, aryloxy, acyloxy, alkylthio, arylthio, heteroarylthio, sulphonyl, sulphoxy, amino, alkylamino, dialkylamino, acylamino, diacylamino, alkoxycarbonylamino, amides, alkyl, branched alkyl, aryl, heteroaryl, nitro, cyano, halogeno, silyloxy, keto, heterocycles, fused ring systems, and fused heterocycles. The alkyl is selected from the group consisting of linear alkyl, branched alkyl and cyclic alkyls.

Preferably, R1, R2, R3, R4, R5 and R6 independently are selected from the group consisting of —H, —OH and amino.

In yet another embodiment of the invention x=4. Accordingly, L, may have the structure 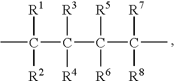
wherein R¹, R², R³, R⁴, R⁵, R⁶, R⁷ and R⁶ independently may be selected from the group of functionalities consisting of H, hydroxy, alkoxy, aryloxy, acyloxy, thiol, alkylthio, arylthio, heteroarylthio, sulphonyl, sulphoxy, amino, alkylamino, dialkylamino, acylamino, diacylamino, alkoxycarbonylamino, amides, alkyl, branched alkyl, aryl, heteroaryl, nitro, cyano, halogeno, silyloxy, keto, heterocycles, fused ring systems, fused heterocycles and mixtures thereof, wherein each of the aforementioned may be substituted with one or more groups selected from the group consisting of —H, —OH, —SH, halogen, carboxyl, carbonyl, alkoxy, aryloxy, acyloxy, alkylthio, arylthio, heteroarylthio, sulphonyl, sulphoxy, amino, alkylamino, dialkylamino, acylamino, diacylamino, alkoxycarbonylamino, amides, alkyl, aryl, heteroaryl, nitro, cyano, halogeno, silyloxy, keto, heterocycles, fused ring systems, and fused heterocycles.

The acidic group of the MABB may be any suitable acidic group capable of forming an amide bond. Preferably, the acidic group is selected from the group consisting of —CO (carbonyl), —CS, —SO₂H, —SO₃H, —PO₂H and —PO₃H. Most preferably, the acidic group is a carbonyl group.

The amide group within the precursor molecule is thus preferably an amide group selected from the group consisting of carbonyl amide, thiocarbonyl amide, phosphinic amide, phosphonic amide, sulfonic acid amide and sulfinic acid amide. Depending on the nature of the acidic group, the precursor molecule may be capable of forming an N—X— iminium ion, wherein X may be for example acyl, thioacyl, phosphinyl, phosphonyl, sulfonyl or sulfinyl. Preferably, the acidic group is a carbonyl group and the precursor molecule is thus capable of forming an N-acyliminium ion. The heterocyclic organic compound, which may be prepared from a given precursor molecule is also dependent on the nature of the acidic group. The heterocyclic organic compound comprises at least two fused rings designated A and B, wherein ring A incorporates a group derived from the acidic group, for example a carbonyl, thiocarbonyl, phosphoroxy, phosphono, sulphono, or sulphoxy group. In a preferred embodiment, the acidic group is a carbonyl group, and thus ring A will incorporate a carbonyl group.

Examples of MABB useful for the present invention for example includes the structures MABB 1 to 9, wherein each of said structure further may be subsituted with one or more of the above mentioned functionalities as well as derivatives thereof. 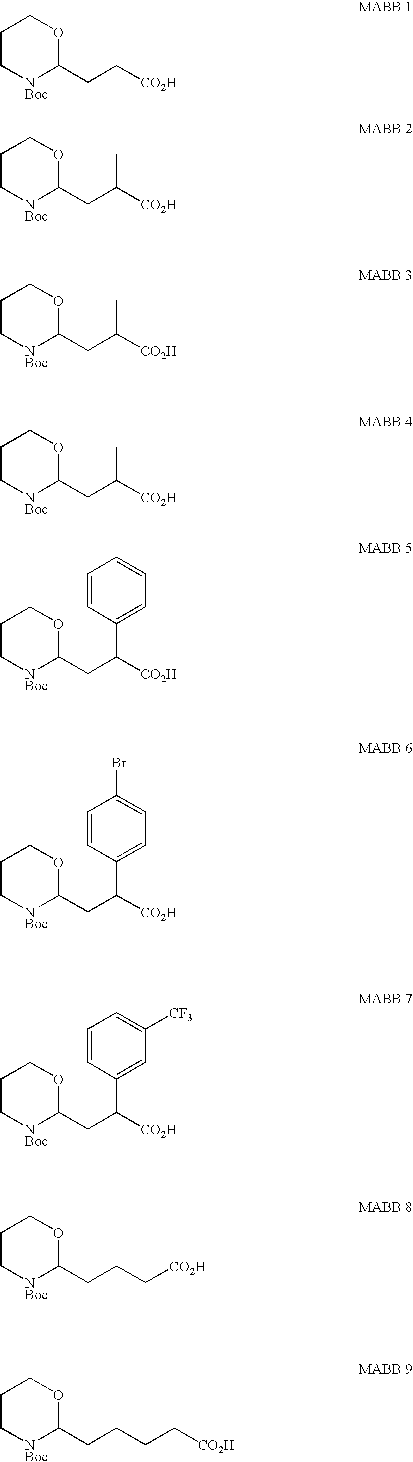
Amino Acid

The precursor molecules or the scaffolds according to the present invention may comprise one or more amino acids linked the MABB and the NuBB, i.e. the MABB and the NuBB may be linked by (AA)ₙ. However, it is also comprised within the present invention that the MABB is directly linked to the NuBB via an amide bond, i.e. n=0.

The amino acid may be any amino acid of the generel formula NHCR¹R²CO—, wherein R¹ and R² may be any suitable side chain. n is an integer in the range of 0 to 5, such as 1, for example 2, such as 3, for example 4.

In one embodiment of the invention AA is an amino acid selected from the group consisting of naturally occurring amino acids, unnatural α-amino acids, and unnatural β-amino acids. Naturally occurring amino acids are the amino acids naturally found in proteins of living organisms.

Non-limiting examples of suitable amino acids are given in FIG. 6.

It is comprised within the present invention that one or more amino acids are protected by an amino acid protecting group, i.e. the amine of the amino acid is protected by a protecting group. The protecting group may be any substituent, which is not —H. Preferably, said substituent is compatible with the reaction conditions required for performing the methods of preparing a heterocyclic organic compound according to the invention, for example the protecting group may be an alkyl or a substituted alkyl.

In particular, it may be desirable to protect one or more amide nitrogens when the precursor comprises more than one amide group, in order to direct the reaction between the aldehyde and the amide group to a specific amide group.

Heterocyclic Organic Compound

The present invention relates to heterocyclic organic compounds, to precursors useful for preparing such compounds and to methods of preparing said compounds. Heterocyclic organic compounds according to the invention comprises at least 2 fused rings designated A and B, wherein ring A incorporates a carbonyl group and ring A and B shares at least one N atom.

Hence, preferably ring A is a lactam. It is preferred that ring A is a in the range of 4 to 11 membered heterocycle, preferably in the range of 5 to 8 membered heterocycle. For example ring A may be a 5 membered, such as a 6 membered, for example a 7 membered, such as a 8 membered ring.

Ring B is preferably a 6 membered heterocycle or a 5 membered heterocycle.

The heterocyclic organic compound may comprise more than 2 fused rings, for example 3, such as 4, for example 5, such as 6, for example 7, such as 8, for example 9, such as 10, for example more than 10 fused rings. It is preferred that at least some of said rings are derived from the nucleophile chemical entity. By way of example, if the nucleophile chemical entity comprises 1 ring, then preferably 1 ring of the heterocyclic organic compound is derived from said nucleophilic chemical entity or if the nucleophile chemical entity comprises 2 fused rings, then preferably 2 fused rings of the heterocyclic organic compound is derived from said nucleophilic chemical entity

The fused rings of the heterocyclic organic compound may be indepently substituted on every position, for example the fused rings may be substituted with one or more selected from the group consisting of H, hydroxy, alkoxy, aryloxy, acyloxy, thiol, alkylthio, arylthio, heteroarylthio, sulphonyl, sulphoxy, amino, alkylamino, dialkylamino, acylamino, diacylamino, alkoxycarbonylamino, alkyl, branched alkyl, aryl, heteroaryl, nitro, cyano, halogeno, and silyloxy,

Hence, in one embodiment of the invention the heterocyclic organic compound comprises 3 fused rings. In this embodiment of the invention it is preferred that one ring is derived from the nucleophile chemical entity.

In another embodiment of the invention the heterocyclic organic compound comprises 4 fused rings. In this embodiment of the invention it is preferred that 2 rings are derived from the nucleophile chemical entity.

The heterocyclic organic compound may in one preferred embodiment of the invention be covalently linked to any of the solid supports mentioned herein below.

Dependent on the nature of the precursor molecule, the heterocyclic organic compound may comprise fused rings of different size.

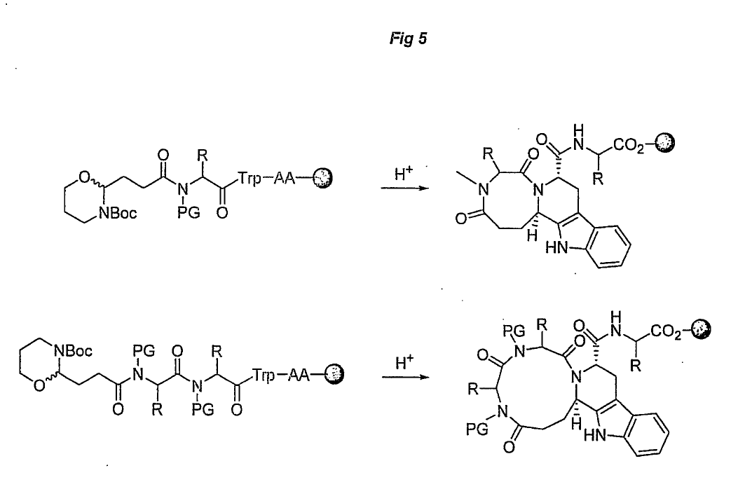

For example, if the masked aldehyde is situated relatively distant from the first available amide group, said precursor molecule may be useful for preparation of a heterocyclic organic compound, comprising a relatively large ring A. By way of example, FIG. 5 illustrates examples of precursor molecules that may give rise to an 8 membered or an 11 membered ring A.

Non-limiting, Illustrative examples of heterocyclic organic compounds that may be prepared according to the methods of the present invention are given in example 3.

In one embodiment of the invention, the heterocyclic compound, be any of the compounds prepared by the methods described herein below. Preferably, the heterocyclic compound then comprises at least 2 fused rings designated A and B, wherein ring A incorporates a carbonyl group and ring A and B shares at least one N atom, wherein said compound comprises or consists of
a) a 7,5, or a 7,6-bicyclic scaffold, or,
b) a 5,5,5-, a 5,6,5-, a 5,5,8-, or a 5,6,8-tricyclic scaffold, or,
c) a 6,5,5-, a 6,6,5-, a 6,5,8-, or a 6,6,8-tricyclic scaffold, or,
d) a 6,5,5,5-, a 6,5,6,5-, a 6,5,5,8-, a 6,5,6,8-tetracyclic scaffold, or,
e) extensions of any of the scaffolds mentioned in a) to d) comprising at least one further ring fused to said scaffold,
   wherein each of said scaffolds may be independently substituted on every position.

By the term X,Y-bicyclic scaffold is meant a ring system of 2 fused rings, wherein one ring is a X-membered ring and the other ring is a Y-membered ring. Scaffolds comprising more rings are named analogously.

In this embodiment of the invention it is particularly preferred that the compound is covalently attached to a solid support.

The scaffolds may be independently substituted on every position, for example they may be substituted with one or more selected from the group consisting of H, hydroxy, alkoxy, aryloxy, acyloxy, thiol, alkylthio, arylthio, heteroarylthlo, sulphonyl, sulphoxy, amino, alkylamino, dialkylamino, acylamino, diacylamino, alkoxycarbonylamino, amides, alkyl, branched alkyl, aryl, heteroaryl, nitro, cyano, halogeno, silyloxy, keto, heterocycles, fused ring systems, fused heterocycles and mixtures thereof, wherein each of the aforementioned may be substituted with one or more groups selected from the group consisting of —H, —OH, —SH, halogen, carboxyl, carbonyl, alkoxy, aryloxy, acyloxy, alkylthio, arylthio, heteroarylthio, sulphonyl, sulphoxy, amino, alkylamino, dialkylamino, acylamino, diacylamino, alkoxycarbonylamino, amides, alkyl, branched alkyl, aryl, heteroaryl, nitro, cyano, halogeno, silyloxy, keto, heterocycles, fused ring systems, and fused heterocycles.

In one embodiment of the invention, the heterocyclic organic compound may be subjected to additional chemical synthesis steps. For example, the heterocyclic organic compound may be deoxygenated (see herein below for methods of performing deoxygenation). Thus, in one aspect the present invention relates to deoxygenated heterocyclic organic compounds, wherein said heterocyclic organic compound, may be any of the compounds described herein above. Deoxygenated heterocyclic organic compounds comprise methyl groups in place of carbonyl groups.

Solid Support

The solid support may be any suitable solid support, for example, a polymer bead, thread, pin, sheet, membrane, silicon wafer, a multivessel plate, a microtiter plate, or a grafted polymer unit. Preferably however, the solid support is a resin bead.

The resin bead should preferably be compatible with the chemistry required for preparing the precursor molecules according to the invention and compatible with the chemistry required for preparing the heterocyclic organic compounds according to the methods described by the invention.

Preferred solid supports according to the present invention are resin beads, useful for on-bead synthesis of precursor molecules and/or heterocyclic organic compounds according to the invention. Hence, preferred resins according to the present invention are resins comprising polyethylene glycol. PEGA (PolyEthyleneGlycol Acrylamide copolymer; Meldal M., 1992, Tetrahedron Lett., 33: 3077-80), POEPOP (PolyOxyEthylene-PolyOxyPropylene; Renil et al., 1996, Tetrahedron Lett., 37: 6185-88) and SPOCC (Super Permeable Organic Combinatorial Chemistry; Rademann et al, 1999, J. Am. Chem. Soc., 121: 5459-66) resins are made primarily of polyethylene glycol and swell well in organic as well as aqueous solvents. Furthermore, these resins are available in different pore sizes.

In one preferred embodiment of the invention the resin beads are selected from the group consisting of Jandagel® and resin beads comprising polyethylene glycol (PEG). For example, resin beads comprising polyehtylene glycol may be selected from the group consisting of PolyEthyleneGlycol Acrylamide copolymer (PEGA), or PolyOxyEthylene-PolyOxyPropylene (POEPOP), Super Permeable Organic Combinatorial Chemistry (SPOCC), POEPS and Tentagel®.

The precursor molecules and/or heterocyclic organic molecules according to the invention may be directly attached to a solid support or indirectly attached via a variety of linkers, preferably by covalent bonds (For reviews describing linkers for solid phase synthesis, see: Backes et al., 1997, Curr. Opin. Chem. Biol., 1: 86-93; Gordon et al., 1999, J. Chem. Technol. Biotechnol., 74: 835-851). The linkers are preferably cleavable, for example the linkers may be acid labile (for example, the Rink amide as described in Rink, 1987, Tetrahedron Lett., 28: 387 and traceless silyl linkers as described in Plunkett et al., 1995, J. Org. Chem., 60: 6006-7), base labile (for example, HMBA as described in Atherton et al. 1981, J. Chem. Soc. Perkin Trans, 1: 538), or photolabile (for example, 2-nitrobenzyl type as described in Homles et al., 1995, J. Org. Chem., 60: 2318-2319). The linkers may be more specific and restrictive of the type of chemistry performed, such as silyl linkers (for example, those cleaved with fluoride as described in Boehm et al., 1996, J. Org. Chem., 62: 6498-99), allyl linkers (for example, Kunz et al., 1988, Angew. Chem. Int Ed. Engl., 27: 711-713), and the safety catch sulfonamide linker (for example, as described in Kenner et al., 1971, Chem. Commun., 12: 636-7).

Method of Preparing a Precursor Molecule

In one aspect the present invention relates to methods of preparing a precursor molecule as described herein above.

The method comprises the steps of
Providing any of masked aldehyde building block (MABB) described herein above, wherein the acidic group has been derivatised to a corresponding free acidic group
   ii) Providing a molecule of the structure [-(AA)ₙ-NuBB], wherein
AA may be any of the amino acids described herein above and NuBB may be any of the nucleophile building blocks described herein above,
wherein (AA)ₙ is linked to NuBB via an amide bond
   iv) Reacting said MABB with said molecule, thereby forming an amide bond between said MABB and said molecule
   iv) Thereby obtaining a precursor molecule.

The reaction may be performed by any suitable reaction capable of establishing an amide bond between a primary amino group and an acidic group, depending on the nature of the acidic group. The acidic group (also designated AG₂) may be any acidic group capable of reacting with an amino group to form an amide. Preferably, AG₂ is selected from the group consisting of carboxylic acid, carboxylic acid halogenid, sulfonyl halogenid and phosphonyl halogenid. Hence, preferably the amide is selected from the group consisting of carbonyl amide, thiocarbonyl amide, phosphinic amide, phosphonic amide, sulfonic acid amide and sulfinic acid amide.

In a preferred embodiment of the invention the acidic group AG₂ is a carboxylic acid. In said embodiment it is preferred, that the reaction may be performed by incubation in the presence of an activator of carboxylic acids. Said activator may for example be any of the activators of carboxylic acids mentioned herein below, for example said reaction may be performed by incubation in the presence of TBTU.

The MABB (masked aldehyde building block) may be prepared by any method suitable for preparing a compound comprising a masked aldehyde and a free carboxylic acid. Non-limiting examples of how MABB may be prepared are given in example 1. The molecule of the structure [-(AA)ₙ-NuBB] may also be prepared by any suitable method known to the person skilled in the art.

In a preferred embodiment of the invention the method comprises the steps of
i) Providing a reactive amino group
ii) Providing a first amino acid, wherein the amino group of said first amino acid is protected by an amino group protecting entity
iii) Forming an amide bond between said reactive amine group and the carboxyl group of said amino acid, by incubating the reactive amine and the amino acid in the presence of an activator of carboxylic acids,
iv) Thereby obtaining a first AA containing molecule.

Optionally, the method may further comprise the steps of
v) Providing a second amino acid, wherein the amino group of said second amino acid is protected by an amino group protecting entity
vi) Deprotecting said first AA containing molecule by removing the amino group protecting entity
vii) Forming an amide bond between the deprotected amino group of the first AA containing molecule and the carboxyl group of the second amino acid, by incubating the first M containing molecule and the amino acid in the presence of an activator of carboxylic acids,
viii) Thereby obtaining a second M containing molecule.

Optionally, the steps v) to viii) may be repeated z times, wherein a third, a 4^{th}, a 5^{th} and so forth amino acid is provided, thereby obtaining a third, a 4^{th}, a 5^{th} and so forth AA containing molecule. z is an integer, preferably an integer in the range of 0 to 5.

The first amino acid and any of the further amino acids provided, may for example be any of the amino acids mentioned herein above. At least one of the amino acids provided should comprise a nucleophilic chemical entity, for example any of the nucleophilic chemical entities mentioned herein above. It is preferred that the first amino acid comprises a nucleophilic chemical entity.

Thus for example if the first amino acid comprises a nucleophilic chemical entity, for example any of the nucleophilic chemical entities mentioned herein above, then the method may only comprise steps i) to iv) and first M containing molecule may be a molecule of the structure [-(AA)ₙ-NuBB], wherein n=0. It is also possible that the method comprises steps i) to viii) and that the second AA containing molecule is a molecule of the structure [-(AA)ₙ-NuBB], wherein n=1.

Said reactive amino group provided may be any reactive amino group, for example said reactive amino group may be part of an amino acid, it may be coupled to a solid support, such as any of the solid supports mentioned herein above, or it may for example be part of a peptide, a polypeptide or an alkyl amine. The reactive amine may thus for example be coupled directly to a solid support or it may be coupled to said solid support via a linker, such as a cleavable linker. Examples of suitable linkers are given herein above.

The activator of carboxylic acid may be any compound capable of activating a carboxylic acid in a manner so that it is capable of reacting with an amino group thereby forming an amide bond. I.e. the activator of carboxylic acids may be any coupling reagent allowing peptide-bond formation. For example the activator of carboxylic acids may be selected from the group consisting of BOP, PyBOP, HBTU, TBTU, TNTU, TSTU, PyBrOP, HOBt, DCC, DCU, DIPCDI, TBMCDI, DMAP, PyBroP and WSC-HCl, more preferably the activator of carboxylic acids may be selected from the group consisting of BOP, PyBOP, HBTU, TBTU, TNTU, TSTU, PyBrOP, HOBt (also useful are DCC, DCU, DIPCDI,

The amino group protecting entity may be any molecular entity capable of protecting an amino acid from reaction with a carboxylic acid, for example any of the commonly used protecting groups in peptide synthesis. For example, the amino group protecting entity may be selected from the group consisting of Fmoc, Boc, Aloc, Adpoc, Pmc, Ac, Bz, Bzl, Mob, Dod, Dmob, Tmob and combinations thereof. Depending on the nature of the amino group protecting entity, said amino group protecting entity may be removed by for example acidic treatment, alkaline treatment, acidic or alkaline treatment at a defined pH, flourid treatment or treatment with a metal or metalk ion.

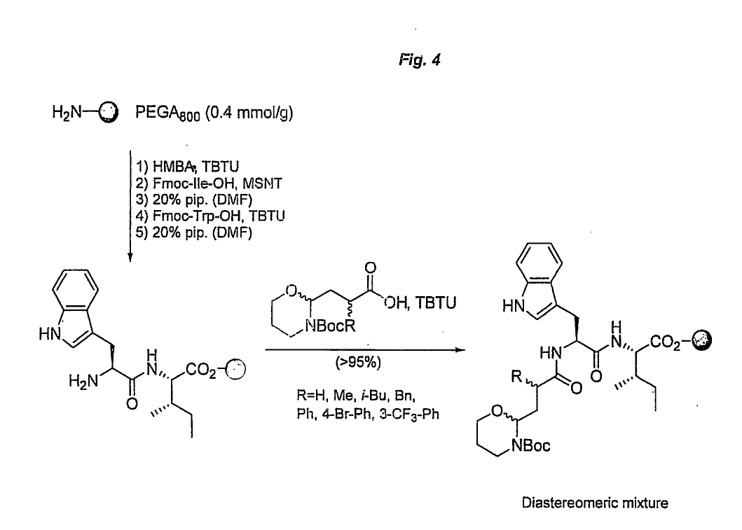

One illustrative, but non-limiting example of a method to prepare a precursor molecule according to the invention is shown in FIG. 4.

Method of Preparing a Heterocyclic Organic Compound

The present invention also relates to methods of preparing a heterocyclic organic compound comprising at least 2 fused rings designated A and B, wherein ring A incorporates a carbonyl group and ring A and B shares at least one N atom, said method comprising the steps of
i) Providing any of the precursor molecules described herein above
ii) Transforming the masked aldehyde into a free aldehyde
iii) Reacting said free aldehyde with an amide group within said precursor molecule, thereby obtaining a cyclic N-acyliminium ion, wherein said N-acyliminium ion is capable of acting as an electrophile
iv) Performing an intramolecular nucleophilic reaction involving the N-acyliminium ion and the nucleophilic chemical entity forming a new covalent bond, thereby obtaining said cyclic organic compound.

The intramolecular nucleophilic reaction may be any cyclization process involving an electronrich double or triple bond, i.e. a n-system leading to the formation of a new covalent bond. Preferably, the n-system comprises an N, O or S atom or a chemical entity which is substituted with an N, O or S atom. In a preferred embodiment the intramolecular nucleophilic reaction is a Pictet Spengler reaction. Examples of Pictet-Spengler reactions are for example reviewed in Cox, E. D.; Cook, J. M. Chem. Rev. 1995, 95, 1797-1842. The “N-acyliminium Pictet Spengler reaction” according to the present invention is also referred to as the “modified Pictet Spengler reaction”. Said new covalent bond is preferably selected from the group consisting of C—C, C—N, C—S and C—O, more preferably said new bond is a C—C bond.

The amide group may for example be selected from the group consisting of carbonyl amide, thiocarbonyl amide, phosphinic amide, phosphonic amide, sulfonic acid amide and sulfinic acid amide. Preferably the amide is a carbonyl amide.

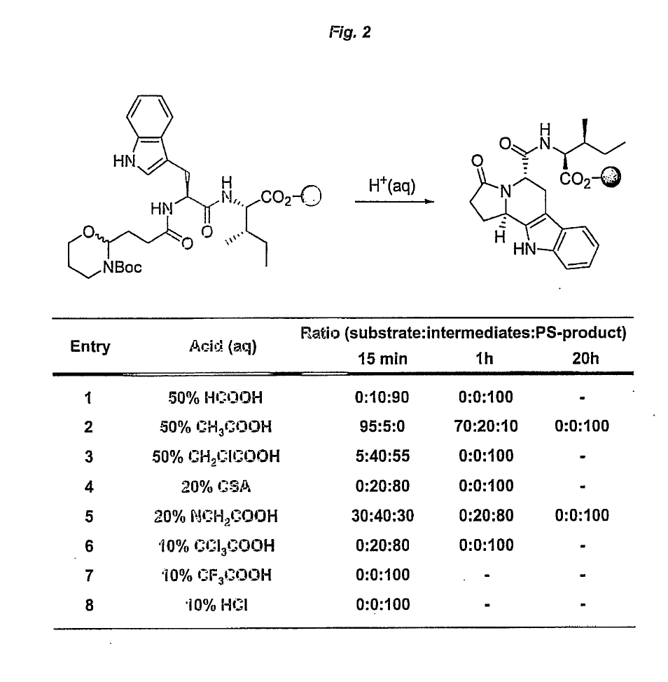

The specific conditions for the nucleophilic reaction should be selected according to the specific nucleophile chemical entity used. In general, the reaction can take place under aqueous conditions or non-aqueous conditions. It is preferable that the reaction, at least can take place under aqueous conditions. This is for ex ample the case when the nucleophile chemical entity comprises a π-system, comprising an N, O or S atom or a chemical entity, which is substituted with an N, O or S atom. This is also the case when the nucleophile chemical entity may comprise one or more electron donating groups, and/or one or more nucleophilic heteroatoms, wherein the electron donating groups and/or the nucleophilic heteroatoms is selected from the group consisting of hydroxy, alkoxy, aryloxy, acyloxy, thiol, alkylthio, arylthio, heteroarylthio, sulphonyl, sulphoxy, amino, alkylamino, dialkylamino, acylamino, diacylamino, alkoxycarbonylamino, mono-, di-, and trisubstituted aromatic and heteroaromatic rings, alkenes, alkynes and combinations thereof. Examples of useful acidic reaction conditions for solid-phase intramolecular N-acyliminium Pictet-Spengler reaction are given in FIG. 2.

When some nucleophile chemical entities are used the reaction cannot be performed under aqueous conditions. However, the reaction can still be performed under non-aqueous conditions. Such nucleophile chemical entities are less preferable. This is for example the case for an unsubstituted phenyl group.

Because the intramolecular nucleophilic reaction in general is very efficient it may normally be performed at room temperature, i.e. at a temperature in the range of 10° C. to around 40° C., preferably in the range of 15° C. to 30° C. It is preferred that the nucleophile chemical entity is selected so that the reaction may be performed at room temperature.

Transforming the masked aldehyde into a free aldehyde should be performed according the nature of the masked aldehyde (see herein above). For examle transforming the masked aldehyde may comprise acid treatment, alkaline treatment, fluoridolysis or hydrogenolysis preferably treatment with acid. The acid may be selected from the group consisting of Brønsted acids and Lewis acids. The Brønsted acid may for example be selected from the group consisting of acetic acid, formic acid, CSA, PTSA, TFA, TCA, HCl and mono- or dichloroacetic acid. In addition the Brønsted acid may be any of the acids mentioned in FIG. 2.

The acid treatment may involve incubation in the presence of in the range of 1 to 10%, such as in the range of 5 to 15%, for example in the range of 10% to 20%, such as in the range of 15 to 25%, for example in the range of 20% to 30%, such as in the range of 25 to 35%, for example in the range of 30% to 40%, such as in the range of 35 to 45%, for example in the range of 40% to 50%, such as in the range of 45 to 55%, for example in the range of 50% to 60%, such as in the range of 55 to 65%, for example in the range of 60 to 70% acid, for example any of the above mentioned acids. Preferably acid treatment involves incubation in the presence of in the range of 10% to 50% acid, dependent on the nature of the acid. For example acid treatment may be as described in FIG. 2.

The acid treatment may be done for any suitable amount of time, for example for in the range of 5 min to 48 hours, preferably for in the range of 5 min to 24 h, such as for in the range of 10 min to 20 hours depending of the nature of the acid. Examples of suitable incubation times for various acids are given in FIG. 2.

Transforming the masked aldehyde into a free aldehyde may also comprise oxidation of an alcohol group to obtain a free aldehyde. Oxidation may be performed according to any suitable method known to the person skilled In the art, for example by Dess-Martin periodinane oxidation, TPAP-oxidation, PDC- or PCC-oxidation or oxidation with activated DMSO, such as the Swam oxidation,

Transforming the masked aldehyde into a free aldehyde may also comprise removing an alcohol protecting group, thereby obtaining a free alcohol and oxidation of said alcohol to obtain a free aldehyde. Dependent on the nature of said alcohol protecting group, it may be removed by treatment with acid, base, fluoridolysis or hydrogenolysis, and subsequently transformed into an aldehyde by oxidation.

In one embodiment of the invention the precursor molecule is attached to a solid support and thus the heterocyclic organic compound will preferably also be attached to said solid support.

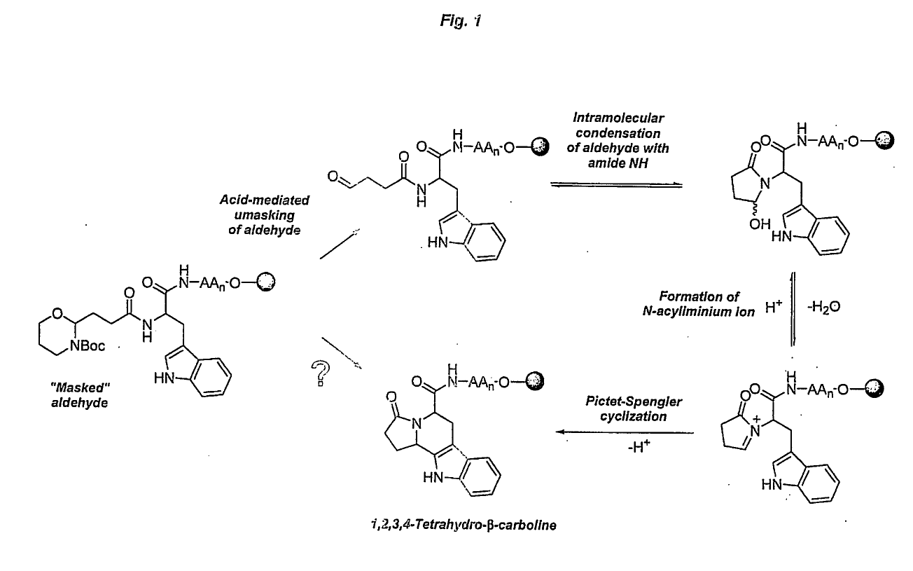

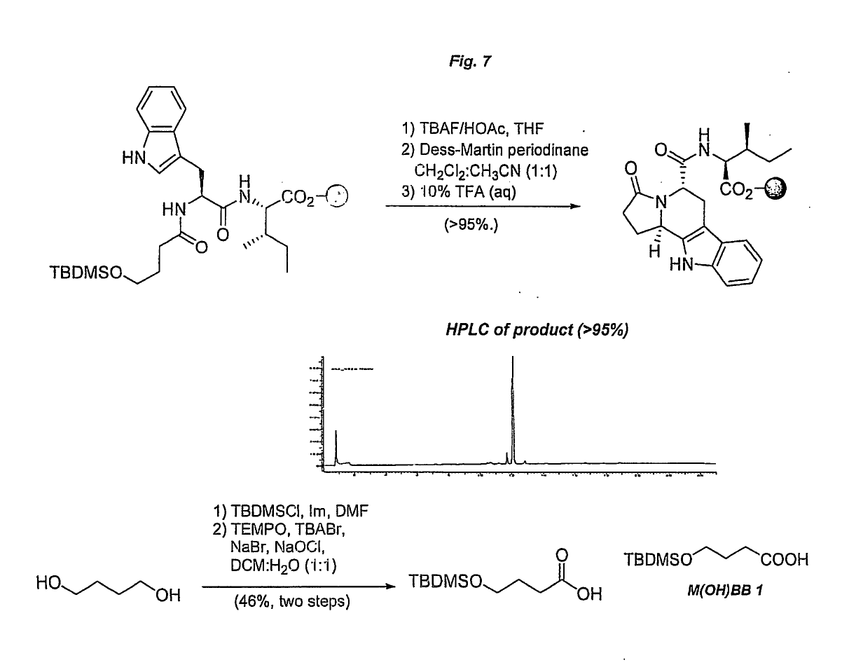

An illustrative, but non-limiting example of preparation of a heterocyclic organic compound according to the invention, wherein the masked aldehyde is masked by an aldehyde protecting group is shown in FIG. 1. Another illustrative, but nonlimiting example of preparation of a heterocyclic organic compound according to the invention, wherein the masked aldehyde is an alcohol protected by an alcohol protecting group is shown in FIG. 7.

The heterocyclic organic compound prepared as described above comprises at least one carbonyl group, i.e. ring A incorporates a carbonyl group. In one embodiment of the invention, the heterocyclic organic compound comprising at least one carbonyl group may be subjected to additional chemical synthesis steps. For example, the heterocyclic organic compound comprising at least one carbonyl group may be deoxygenated. In deoxygenated heterocyclic organic compounds, the carbonyl groups have been deoxygenated to methyl groups. Thus such compounds do not comprise carbonyl groups. Deoxygenation may be performed by hydride treatment, for example by treatment with aluminium or boron based hydride reagents, such as boric hydride or aluminium hydride, for example LiAlH₄. Suitable methods of deoxygenation are for example described in Y. Yu, J. M. Ostresh, R. A. Houghten, J. Org. Chem., 2002, 67:3138-3141.

Library

It is also an aspect of the present invention to provide methods of preparing a library of heterocyclic organic compounds, wherein each comprises at least 2 fused rings designated A and B, wherein ring A is substituted with a carbonyl group and ring A and B shares at least one N atom, said method comprising the steps of
i) Providing at least 2 different precursor molecules, which may be any of the precursor molecules described herein above,
ii) performing any of the methods of preparing a heterocyclic compound for each of said precursor molecules
iii) thereby obtaining a library comprising at least 2 different cyclic organic compounds.

It is also an aspect of the invention to provide libraries prepared by said methods.

Preferably, said method comprises providing at least 10, such as at least 20, for example at least 30, such as at least 40, for example at least 50, such as at least 100, for example at least 500, such as at least 1000 different precursor molecules and hence the libraries preferably comprises at least 10, such as at least 20, for example at least 30, such as at least 40, for example at least 50, such as at least 100, for example at least 500, such as at least 1000 different heterocyclic organic compounds.

In one embodiment of the invention, all precursor molecules provided comprise identical scaffolds, which are differentially substituted, i.e. the core structure of the precursor molecules is identical. For example, all precursor molecules provided may comprise identical masked aldehydes

It is often desirable to keep the library compounds physically separated, for example by keeping the library compounds in different reaction vessels or by attaching the library compounds to different solid supports, such as to different resin beads.

For example, the library may be prepared using parallel synthesis. Alternativly, all precursor molecules provided may be attached to a solid support and hence the heterocyclic compounds may be covalently linked to a solid support. It is preferred that all heterocyclic compounds of the library are covalently linked to a solid support. The solid support may be any of the solid supports mentioned herein above, it is however preferred that the solid support is resin beads. More preferably, a single resin bead only is coupled to one kind of heterocyclic compound.

Each member of the library Is a unique compound and is thus preferably physically separated in space from the other compounds in the library, preferably, by immobilizing the library on resin beads, wherein each bead at the most comprises one member of the library. Depending on the mode of library synthesis, each library member may contain, in addition, fragments of the library member. Since ease and speed are important, it is preferred that the methods of identifying heterocyclic organic compounds described herein below may take place on the same solid support used for synthesis of the library. It is even more preferred that identification of the heterocyclic organic compounds can take place on the same support, such as on a single resin bead. Thus, preferred solid supports useful in the invention satisfy the criteria of not only being suitable for organic synthesis, but are also suitable for screening procedures and identification procedures.

The library of the present invention is preferably a library of heterocyclic compounds, wherein said compounds comprises at least 2 fused rings designated A and B, wherein ring A is substituted with a carbonyl group and ring A and B shares at least one N atom, and wherein a sequence of one or more amino acids is covalently linked to said fused rings, wherein said library is prepared by the method described herein above. Preferably, at least some of said heterocyclic compounds are linked to a solid support, more preferably all heterocyclic compounds are linked to a solid support.

The heterocyclic compounds may comprise more than 2 fused rings, such as 3 fused rings, for example 4 fused rings, such as 5, for example 6, such as more than 6 fused rings. Preferably, the heterocyclic compounds comprises 3 or 4 fused rings. Each ring may individually be a 4 membered, such as a 5 membered, for example a 6 membered, such as a 7 membered, for example an 8 membered, such as a 9 membered, for example a 10 membered, such as a more than 10 membered ring. Preferablyt, each ring may individually be a 5, 6, 7 or 8 membered ring, such as a 5 or 6 membered ring or a 7 or 8 membered ring.

Thus, the library may in one embodiment comprise or even consist of heterocyclic organic compounds comprising fused rings selected from the group consisting of a 5,5,5-, a 5,6,5-, a 5,5,8-, a 5,6,8, a 6,5,5-, a 6,6,5, a 6,5,8-, a 6,6,8-, a 6,5,5,5-, a 6,5,6;5-, a 6,5,5,8- and a 6,5,6,8 membered fused rings.

By the term X, Y, Z membered fused ring is meant a ring system of 3 fused rings, wherein one ring is a X-membered ring, the other ring is a Y-membered ring and the third ring is a Z membered ring. Larger ring systems are named analogously.

Each of the above mentioned fused rings may be independently substituted on each available position.

Said sequence of one or more amino acids may consists of 1, such as 2, for example 3, such as 4, for example 5, such as 6, for example more than 6 amino acids. Said amino acids may be any amino acids, such as naturallly occurring amino acids, not naturally occuring amino acids or a mixture of both.

In one embodiment of the invention the library comprises or consists of compounds of the general formula I:

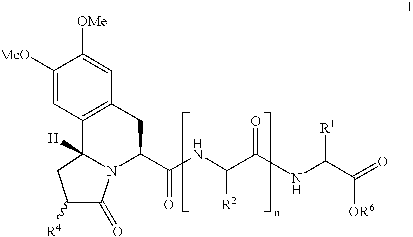

The library may also comprise or consist of compounds of the general formula II:

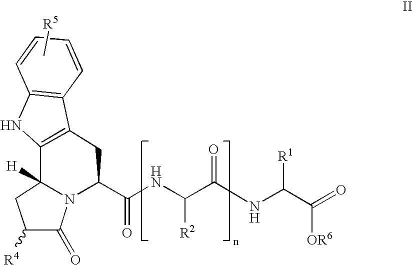

The library may also comprise or consist of compounds of the general formula III:

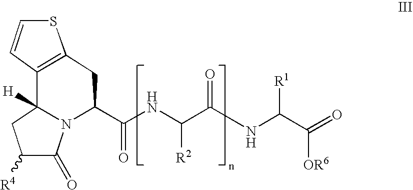

The library may also comprise or consist of compounds of the general formula IV:

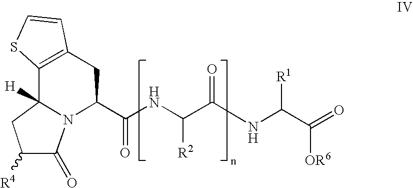

The library may also comprise or consist of compounds of the general formula V:

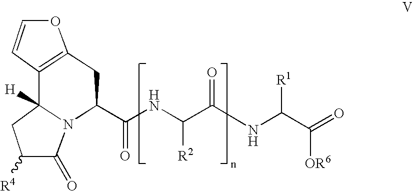

The library may also comprise or consist of compounds of the general formula VI:

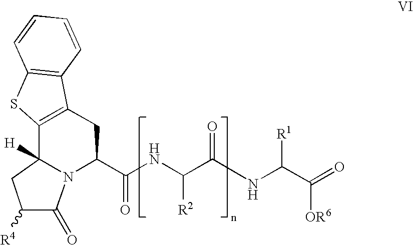

The library may also comprise or consist of any stereoisomeric compounds of the general formulas I-VI

It is also comprised within the present invention that the library may comprise or even consist of a mixture of compounds selected from compounds of the general formula I, formula II, formula III, formula IV, formula V and formula VI.

The R groups indicated in the formulas I to VI may indepedently be selected from the group consisting of amino acid side chains. Once incoporated into the heterocyclic compound the R group may not actually be an amino acid side chain anymore, however they are derived from amino acid side chains. Said amino acids may be naturally occurring or not naturally occurring amino acids or a mixture of both.

Examples of useful amino acids are given in table 1 herein below.

Methods of Identifying a Heterocyclic Organic Compound Capable of Associating with a Cell Surface Molecule

It is also an aspect of the invention to provide methods of identifying a heterocyclic organic compound capable of associating with a cell surface molecule naturally expressed on the surface of a cell, said method comprising the steps of
i) Providing any of the libraries described herein above,
ii) Providing a composition comprising said cell surface molecule,
iii) Incubating said library with said composition
iv) Identifying heterocyclic compounds of said library capable of specifically associating with said cell surface molecule.

The cell surface molecule may in one embodiment be associated with a clinical condition. For example the cell surface molecule may be expressed differentially in diseased versus healthy cells, or the cell surface molecule may be expressed differentially in an individual suffering from said disease versus in an individual not suffering from said disease. For example said cell surface molecule may be overexpressed in diseased cells and/or sick individuals, The cell surface molecule may for example be associated with one or more conditions selected from the group consisting of obesity, cancer, memory disability, learning improvement, sleeping disturbances, systemic pain, convulsion, spetic chock, diseases related to the central nervous system (CNS) for example pain, depressions, maniodepressive state and Parkinsons disease.

The cell surface molecule may be any molecule expressed on the surface of at least one cell, however it is preferred that the cell surface molecule is a protein. For example the cell surface molecule may be a receptor, such as a G-protein coupled receptor.

The G-protein coupled receptor may for example be selected from the group consisting of the melanocortin receptor, morfine receptors such as δ, ω and κ, neuropeptide Y receptor, CB-1, CB-2, benzodiazepin receptor, dopamine receptor, serotonin receptor, epinyl receptor, gastrointestinal neurohormone receptor, oxytocin receptor, verssopressin receptor and CCK.

In order to screen the library for heterocyclic organic compounds capable of associating with a given cell surface molecule, in particular for screening libraries immobilised on a solid support, said cell surface molecule may be labelled with a detectable label. In particular, for G-protein coupled receptors, membrane fragments labelled with a detectable label may be used for the screening. The detectable label may be selected from the group consisting of dyes, flourescent compounds, enzymes, heavy metals and radioactive compounds.

Once a library member capable of associating with a given cell surface molecule has been identified, it is preferred that the nature of said library member is identified. In particular, if the library is immobilised on resin beads, once a bead comprising a heterocyclic organic compound capable of interacting with said cell surface molecule, is will usually be desirable to identify said compound. The heterocyclic organic compounds may be identified may any suitable method known to the person skilled in the art, for example by mass spectrometry, such as MALDITOF MS, LCMS, ES MS, or by ladder synthesis or by NMR, such as MAS NMR or single bead MAS NMR or combinations thereof.

Uses of the Heterocyclic Organic Compounds

The present invention also relates to uses of a heterocyclic organic compound identified according to any of the methods of identifying a heterocyclic organic compound capable of associating with a cell surface molecule described herein above, for the preparation of a medicament for the treatment of a clinical condition in an Individual in need thereof. The clinical condition may for example be selected from the group consisting of cancer, memory disability, learning improvement, sleeping disturbances, systemic pain, convulusion, spetic chock, diseases related to the central nervous system (CNS) for example pain, depressions, maniodepressive state and Parkinsons disease.

The invention also relates to uses of a heterocyclic organic compound identified according to any of the methods of identifying a heterocyclic organic compound capable of associating with a cell surface molecule described herein above for affinity chromatography.

The invention also relates to uses a heterocyclic organic compound identified according to any of the methods of identifying a heterocyclic organic compound capable of associating with a cell surface molecule described herein above for affinity labelling.

The invention also relates to methods of identifying a heterocyclic organic compound capable of acting as a protease inhibitor, said method comprising the steps of
i) Providing any of the libraries of heterocyclic organic compounds described herein above,
ii) Providing a peptide substrate of a protease,
iii) Providing a protease capable of cleaving said substrate
iv) Incubating said library with said peptide substrate and said protease
v) Identifying heterocyclic compounds of said library capable of specifically inhibiting cleavage of said substrate.

Preferably, the peptide substrate is immobilised on a solid support. Even more preferably the heterocyclic organic compounds and the peptide substrate are immobilised on resin beads, wherein each resin bead comprises one kind of heterocyclic compound and a peptide substrate.

It is preferred that cleavage of said peptide substrate results in a detectable change, for example a detectable change in fluorescence.

The invention also relates to uses of a heterocyclic organic compound identified by the method as a protease inhibitor.

### EXAMPLES

The following examples illustrates specific embodiments of the invention and should not be considered limiting for the invention.

### Example 1

Solid-Phase Synthesis and Preparation of MABB

General Methods. All solvents were of HPLC quality and stored over molecular sieves. Solid-phase organic chemistry was routinely carried out using plastic-syringe techniques. Flat bottom PE syringes were equipped with sintered teflon filters (50 μm pores), teflon tubing and valves, which allow suction to be applied to the syringes below. For all reactions on solid support, PEGA₈₀₀ resin (0.4 mmol/g, 150-300 μm, Polymer Laboratories) was used. Prior to use, the resin was washed with methanol (×6), and DMF (×6). Attachment of the 4-hydroxymethylbenzoic acid (HMBA) linker to the amino-functionalized resin: HMBA (3 equiv), N-ethyl morpholine (NEM, 4 equiv), and N-[(1H-benzotriazol-1-yl)-(dimethylamino)methylene]-N-methylmethanaminium tetrafluoroborate N-oxide (TBTU, 2.88 equiv) were premixed for 5 min in DMF. The resulting solution was added to the DMF preswollen resin and allowed to react for 2 h.

Coupling of the first amino acid to the HMBA derivatized resin was accomplished by treating the freshly lyophilized resin with a mixture of N^{α}-Fmoc amino acid (3 equiv), Melm (2.25 equiv), and MSNT (3 equiv) in DCM:THF (20:1). The couplqing was repeated once.

Peptide synthesis and attachment of masked aldehyde building blocks (MABBs) to the amino-functionalized resin were subsequently accomplished following standard amino acid/TBTU/NEM coupling-procedures, as described above for the attachment of the HMBA linker. The usual washing protocol followed each coupling and deprotection step. Completion of the reaction was monitored using the Kaiser test. Fmoc-deprotection was accomplished with 20% piperidine in DMF, first for 2 min, and then for 18 min.

Resin loading was determined by Fmoc cleavage and measurement of the optical density at 290 μm. Loadings were then calculated from a calibration curve. Analysis of all solid-phase reactions was performed after product cleavage from a resin sample: a small resin sample (ca. 50 beads) was treated with 0.1 M aqueous NaOH (20 μL) for 2 h. After neutralization with 0.1 M HCl (20 μL), and addition of MeCN (20 μL), a sample (10 μL) was analyzed via analytical RP-HPLC performed on a Zorbax column (C-18, 300 Å, 50 mm×0.45 mm) column) with a linear gradient of 100% A (0.1% TFA in water) to 100% B (0.1% TFA in MeCN:water (9:1)) in a run-time of 25 min, 1 mL/min, with detection at 215 nm using a photodiode array detector. Material sufficient for ¹H NMR analysis was obtained by cleaving a resin sample (ca. 75-100 mg) as described above. NMR spectra were recorded on a Bruker DPX 250 MHz instrument. High resolution mass spectrometry was performed using ES MSMS techniques.

Masked aldehyde building blocks MABB 14 were synthesized according to previously reported routes (Groth, T.; Meldal, M. J. Comb. Chem. 2001, 3, 33-44; Nielsen, T E; Meldal, M., J. Org. Chem., 2004, 69, 3765-3773).

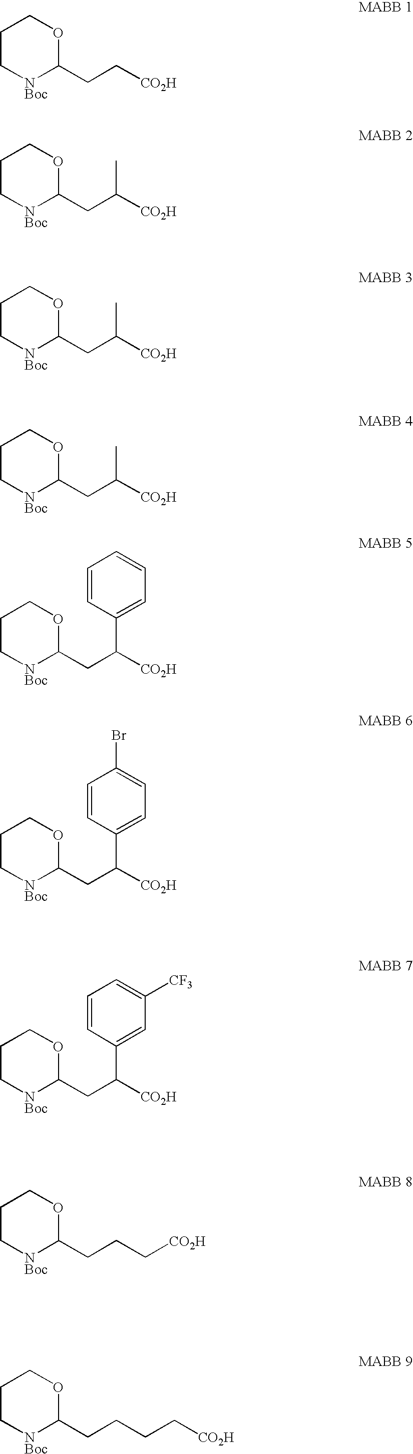

The synthesis of novel masked aldehyde building blocks MABB 5-4 were carried out according to the previously reported procedure for masked aldehyde building blocks MABB 1-4, (Groth, T.; Meldal, M. J. Comb. Chem. 2001, 3, 34-44) as illustrated by the reaction scheme below (with notation of the obatined yields in the individual synthetic transformations):

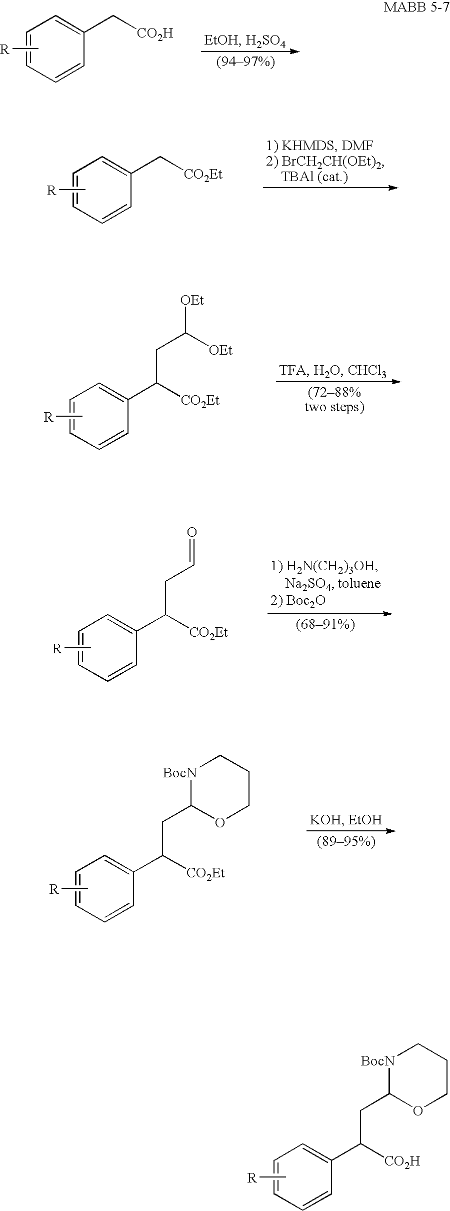

The steps comprising the conversion of intermediate arylacetic acid ethyl esters to the aldehydes of the N-Boc N,O-acetalizaton process deviate from the previously adapted for the synthesis of MABB1-4. This is illustrated below for the synthesis of the aldehyde intermediate towards MABB 5:

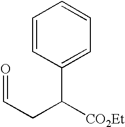

4-Oxo-2(RS)-phenyl-butyric acid ethyl ester. A solution of phenylacetic acid ethyl ester (1.50 mmol, 246 mg, 1.0 equiv) in DMF (10 mL) was added dropwise to a Schlenk tube containing a suspension of KHMDS (1.65 mmol, 329 mg, 1.1 equiv) in DMF (10 mL) at 0° C. The mixture was stirred at 0° C. for 15 min, before the addition of solid TBAI (0.05 mmol, 18 mg, 0.03 equiv) in one portion, followed by dropwise addition of bromoacetaldehyde diethylacetal (1.65 mmol, 325 mg, 1.1 equiv). The resulting solution was allowed to reach 45° C. during 5 min, before quenching with water (20 mL) and addition of hexane (75 mL). The hexane layer was separated, and the aqueous layer was extracted with further portions of hexane (2×25 mL). The combined hexane layers were washed with water (3×25 mL), and brine (3×25 mL). The organic phase was dried over Na₂SO₄, filtered, and rotary evaporated to afford a yellow oil containing the alkylation product. The residue was suspended in 1 mL of water and cooled to 0° C. The suspension was added 6 mL of CHCl₃:TFA (1:1), and stirred for 2 hr at 0° C., where after the reaction mixture was poured into a mixture of 1.0 M K₂CO₃ (15 mL) and DCM (25-mL). Solid K₂CO₃ was added until pH=7.5. The organic layer was separated, and the aqueous layer was extracted with a further amount of DCM (15 mL). The combined organics were washed with water (30 mL), and brine (30 mL), then dried over Na₂SO₄, filtered, and concentrated. The residue was purified by flash column chromatography (petroleum ether:EtOAc; 4:1) on silica-gel to give the title compound as a colorless oil (273 mg, 88%).

The synthesis of novel masked aldehyde building blocks MABB 8-9 were carried out according to the previously reported procedure for the corresponding masked aldehyde building block (e.g where n=2), (Groth, T.; Meldal, M. J. Comb. Chem. 2001, 3, 34-44) as illustrated by the reaction scheme below (with notation of the obtained yields in the individual synthetic transformations):

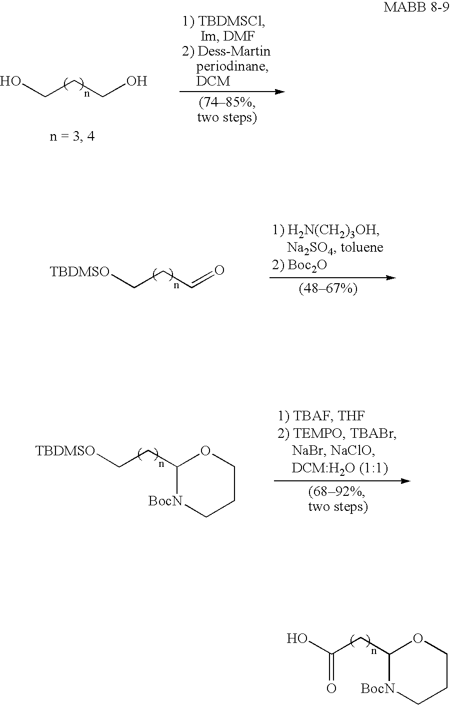

### Example 2

Potential substrates for Pictet-Spengler reactions 1—variation of MABBs exemplified by their attachment to a Trp-Ile residue. The following substrates were made for testing in the solid-phase Pictet-Spengler reactions of the present invention.

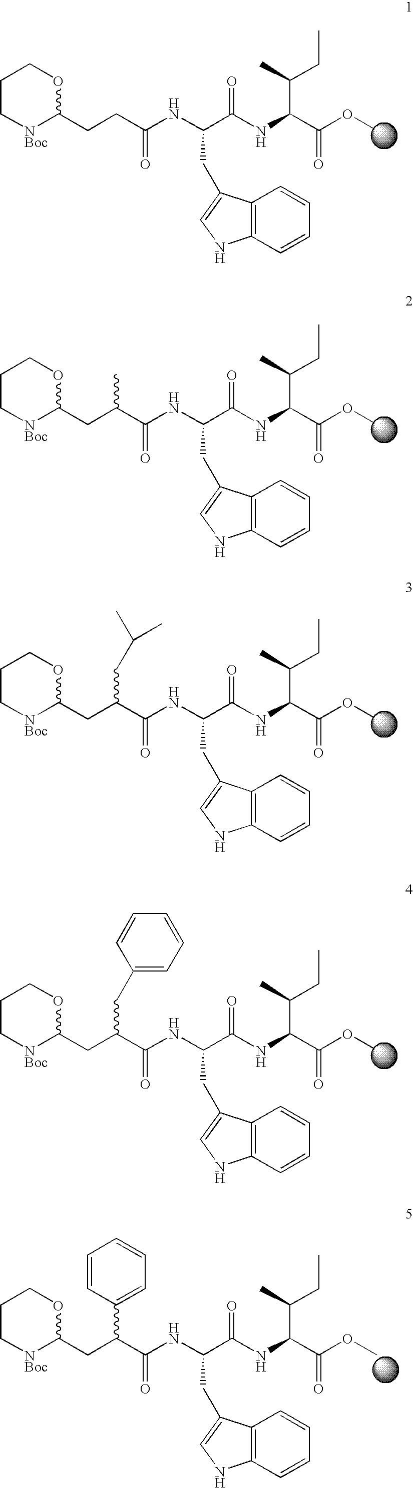

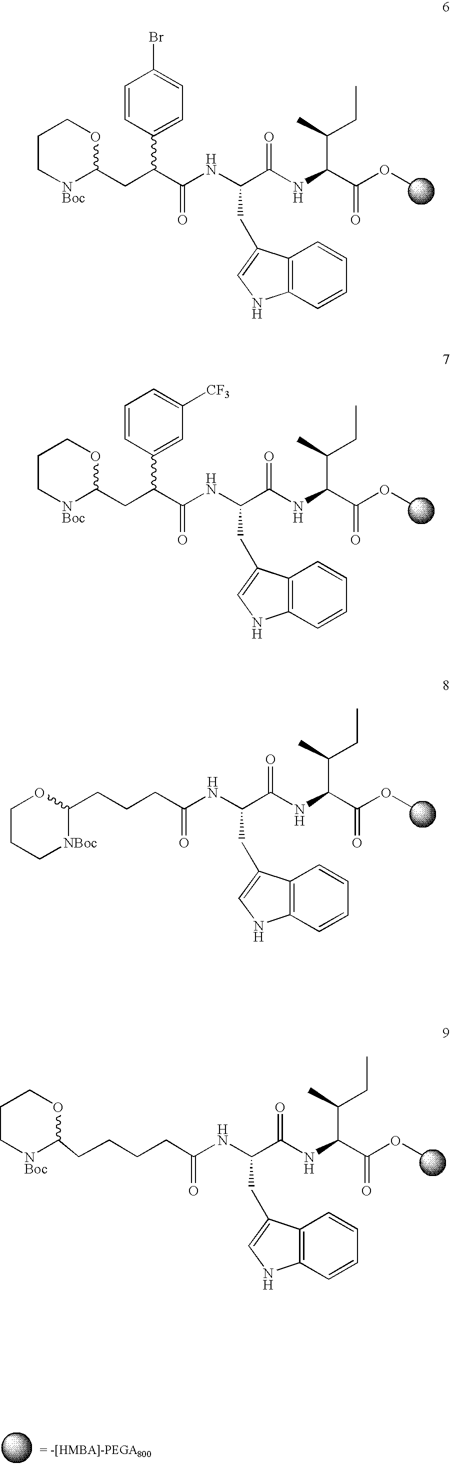

These substrates are generally referred to as MABBX-Trp-Ile-OH when liberated from the solid support.

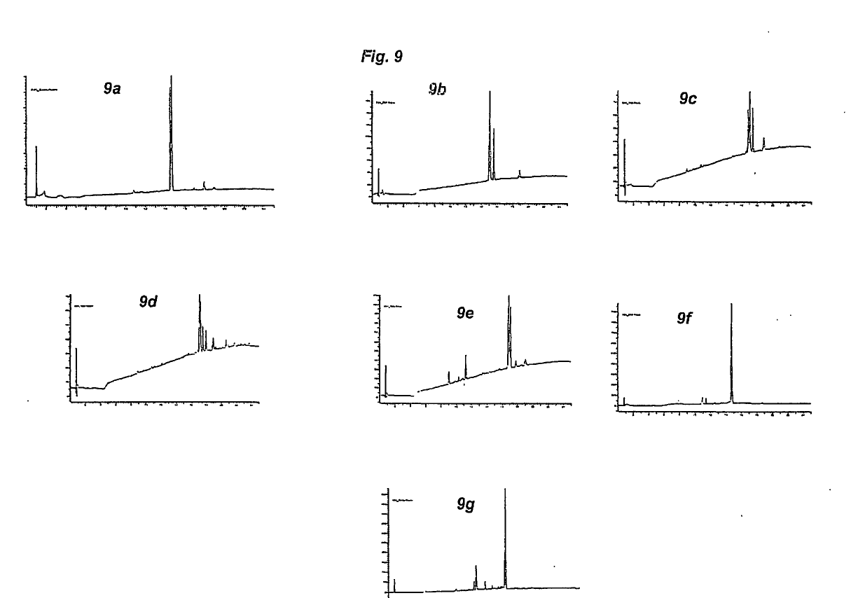

Representative analytical HPLCs and MS for Pictet-Spengler reaction substrates 1 released from solid phase as the carboxylic acid derivatives (FIG. 9):

MABB1-Trp-Ile-OH (1) (FIG. 9a). Purity: >95%; Rₜ=14.54 min, 14.67 min; HRMS (ESI) calcd for C₂₉H₄₃N₄O₇ [M+H]⁺559.3132, found 559.3166.

MABB2-Trp-Ile-OH (2) (FIG. 9b). Purity: >95%; Rₜ=14.94 min, 15.06 min (overlapping peaks); 15.56 min; HRMS (ESI) calcd for C₃₀H₄₅N₄O₇ [M+H]⁺573.3288, found 573.3325.

MABB3-Trp-Ile-OH (3) (FIG. 9c). Purity: >95%; Rₜ=16.80 min, 16.92 min, 17.05 min, 17.41 min; HRMS (ESI) calcd for C₃₃H₅₁N₄O₇ [M+H]⁺615.3758, found 615.3765.

MAB84-Trp-Ile-OH (4) (FIG. 9d). Purity: >95%; Rₜ=17.04 min. (overlapping peaks), 17.20 min, 17.50 min; HRMS (ESI) calcd for C₃₆H₄₉N₄O₇ [M+H]⁺649.3601, found 649.3625.

M-ABB5-Trp-Ile-OH (5) (FIG. 9e). Purity; >95%; Rₜ=16.64 min. (overlapping peaks), 16.86 min; HRMS (ESI) calcd for “H₄₇N₄O₇ [M+H]⁺635.3445, found 635.3489.

MABB-Trn-Ile-OH (8) (FIG. 9f)

MABB9-Trp-Ile-OH (9) (FIG. 9g)

Potential substrates for Pictet-Spengler reactions 2—variation of substituents on (racemic) Trp derivatives exemplified by their incorporation between MABB1 and Ile. The following substrates were made for testing in the solid-phase Pictet-Spengler reactions of the present invention.

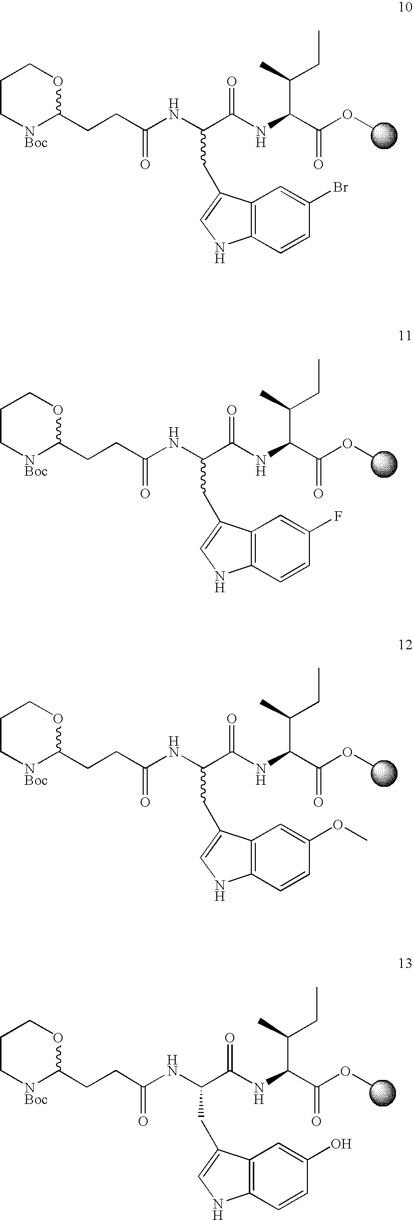

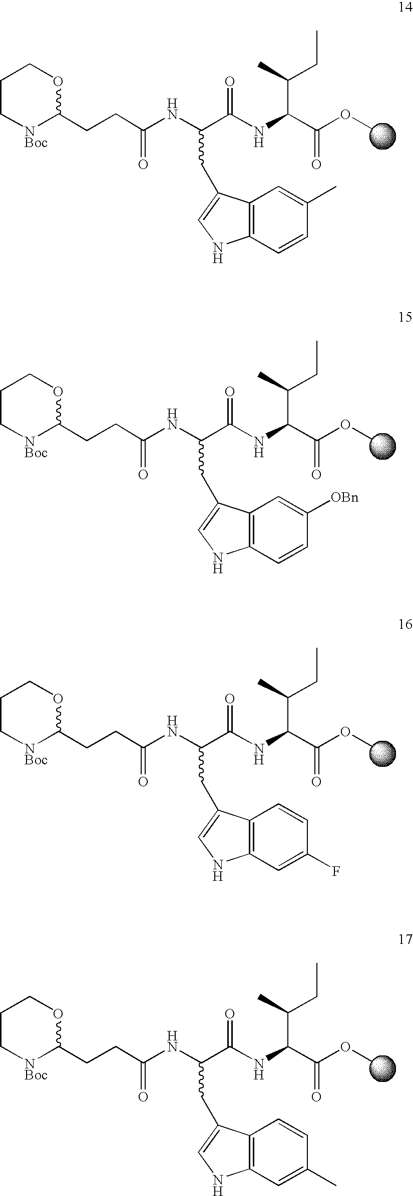

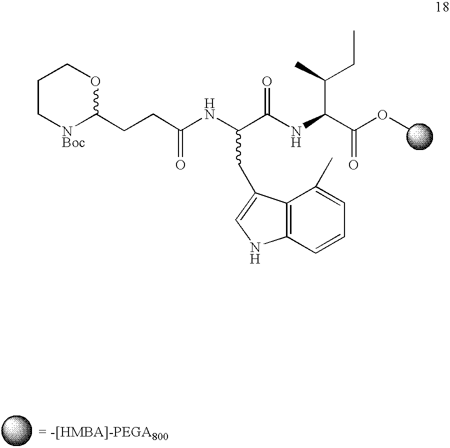

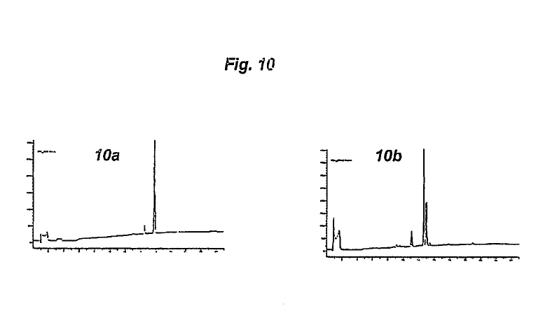

Representative analytical HPLCs and MS for Pictet-Spengler reaction substrates 2 released from solid phase as the carboxylic acid derivatives (FIG. 10):

MABB1-(5-Br-(D/L)Trp-Ile-OH (10) (FIG. 10a). Purity: >95%; Rₜ=15.69 min, 15.79 min (overlapping peaks); HRMS (ESI) calcd for C₂₉H₄₂BrN₄O₇ [M+H]⁺637.2237, found 637.2281.

MABB1-(5-OH)Trp-Ile-OH (13) (FIG. 10b). Purity: >95%; Rₜ=12.78 min, 12.92 min; HRMS (ESI) calcd for C₂₉H₄N₄O₈ [M+H]⁺575.3081, found 575.3112.

Potential substrates for Pictet-Spengler reactions 3—variation of the aromatic side chain exemplified by the incorporation of aryl-Ala derivatives between MABB1 and Ile. The following substrates were made for testing in the solid-phase Pictet-Spengler reactions of the present invention.

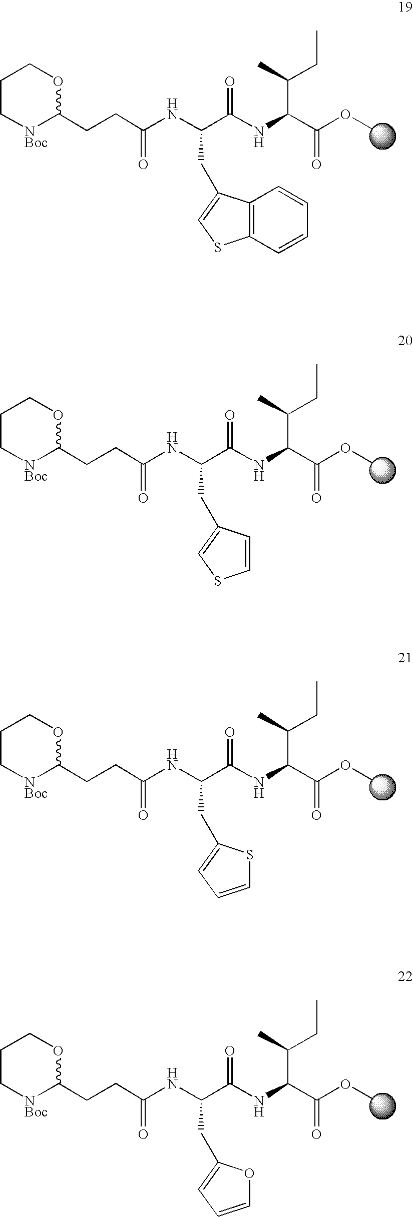

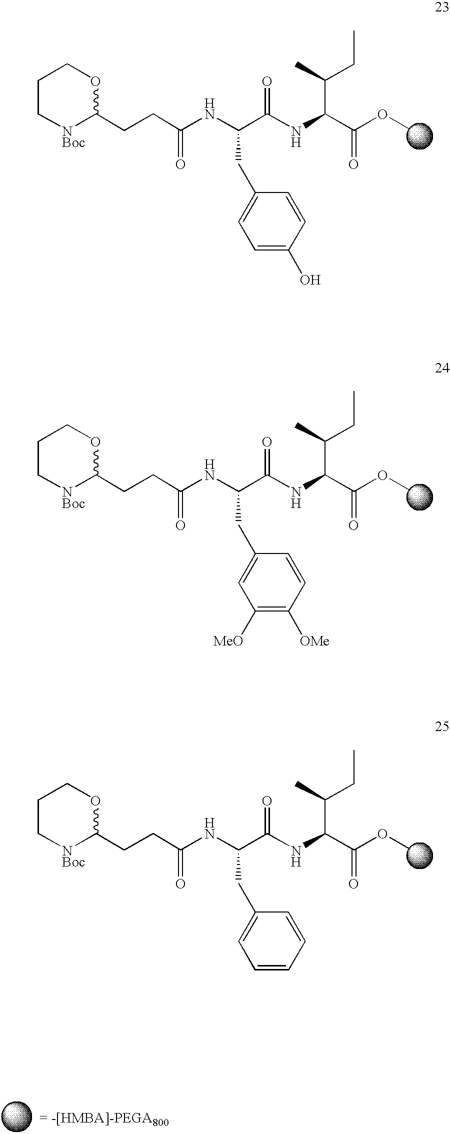

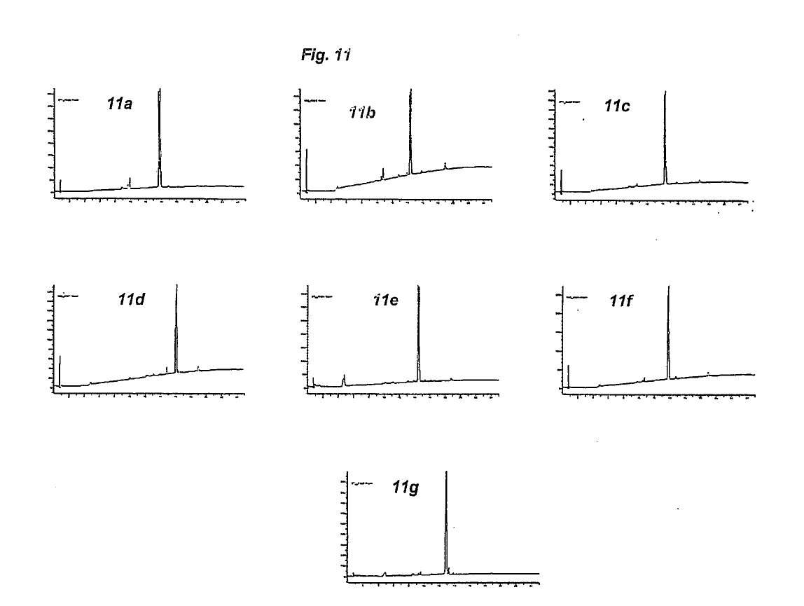

Representative analytical HPLCs and MS for Pictet-Spengler reaction substrates 3 released frin solid phase as the carboxylic acid derivatives (FIG. 11):

MABB1-(3-(2-furyl)Ala)-Ile-OH (22) (FIG. 11a). Purity: >95%; Rₜ=13.66 min, 13.84 min; HRMS (ESI) calcd for C₂₅H₄₀N₃O₈ [M+H]⁺510.2815, found 510.2824.

MABB1-(3-(2-thienyl)Ala)-Ile-OH (21) (FIG. 11b). Purity: >95%; Rₜ=14.17 min, 14.31 min; HRMS (ESI) calcd for C₂₅H₄₀N₃O₇S [M+H]⁺526.2587, found 526.2635.

MABB1-(3-(3-thienyl)Ala)-Ile-OH (20) (FIG. 11c). Purity: >95%; Rₜ=14.20 min, 14.34 min; HRMS (ESI) calcd for C₂₅H₄₀N₃O₇S [M+H]⁺526.2587, found 526.2610.

MABB1-(3-(3-benzothienyl)Ala)-Ile-OH (19) (FIG. 11d). Purity: >95%; Rₜ=15.84 min, 15.94 min; HRMS (ESI) calcd for C₂₉H₄₂N₃O₇S [M+H]⁺576.2743, found 576.2798.

MABB1-Phe-Ile-OH (25) (FIG. 11e)

MABB1-(3,4-dimethoxy-Phe)-Ile-OH (24) (FIG. 11f). Purity: >95%; Rₜ=13.64 min, 13.73 min; HRMS (ESI) calcd for C₂₉H₄₆₆N₃O₉ [M+H]⁺580.3234, found 580.3267.

MABB1-Tyr-Ile-ON (23) (FIG. 11g)

General procedure for solid-phase Pictet-Spengler reactions. The solid-supported Pictet-Spengler reaction substrate was swelled in 10% TFA (aq.), and reacted for 2 h, before washing the resin with water (×6), DMF (×6), and DCM (×6). The resin was briefly lyophilized prior to cleavage of the reaction product from the solid support.

### Example 3

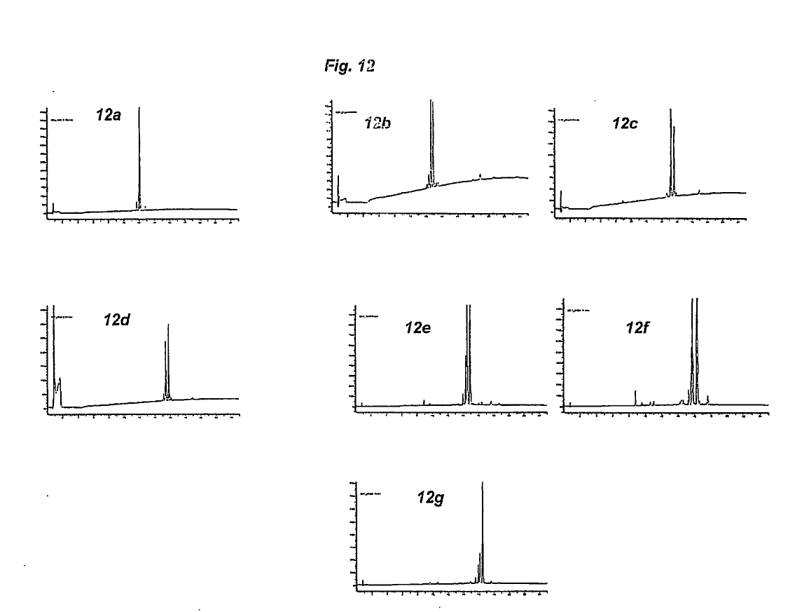

Possible Pictet-Spengler reaction products 1—variation of MABBs. The following products may be obtained via the solid-phase Pictet-Spengler reactions of the present invention. 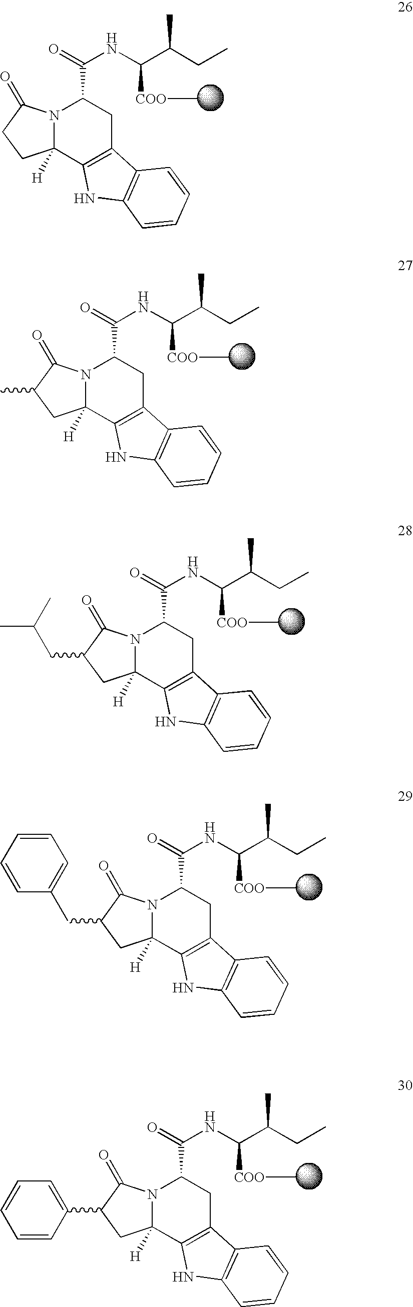 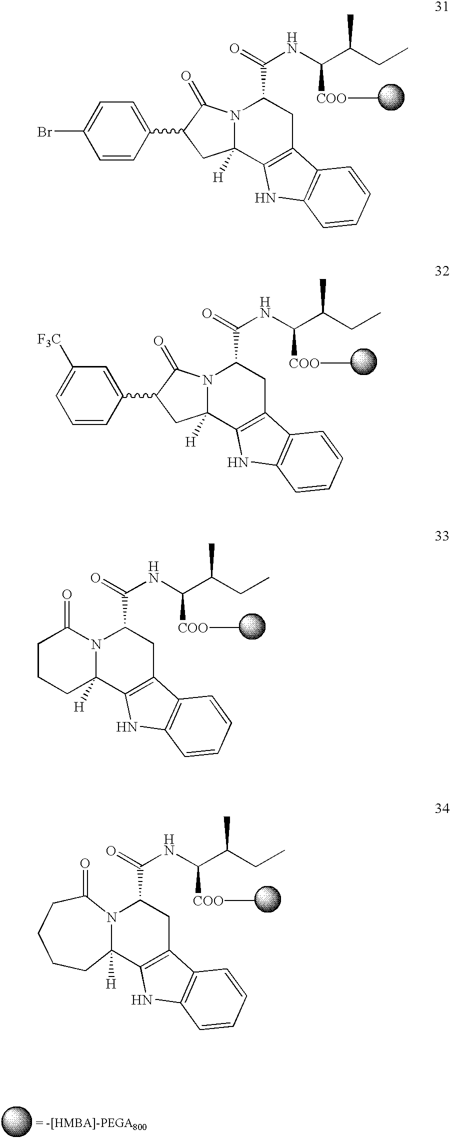
Representative Analytical HPLCs and MS for Pictet-Spengler Reaction Products 1 Released from Solid Phase as the Carboxylic Acid Derivatives (FIG. 12):

Pictet-Spengler reaction product of MABB1-Trp-Ile-OH (26) (FIG. 12a). Purity: >95%; Rₜ=11.96 min; ¹H NMR (250 MHz, CD₃CN) δ 7.44 (d, J=7.5 Hz, 1H), 7.32 (d, J=8.0 Hz, 1H), 7.14-6.92 (m, 2H), 5.16-5.08 (m, 2H), 4.08 (d, J=5.8 Hz, 1H), 3.40 (d, J=15.8 Hz, 1H), 3.01-2.80 (m, 1H), 2.80-2.52 (m, 2H), 2.50.2.29 (m, 1H), 1.95-1.62 (m, 2H), 1.35-1.16 (m, 1H), 1.03-0.78 (m, 1H), 0.76-0.55 (m, 6H); HRMS (ESI) calcd for C₂₁H₂₆N₃O₄ [M+H]⁺384.1923, found 384.1911.

Pictet-Spengler reaction products of MABB2-Trp-Ile-OH (27) (FIG. 12b). Purity: >95%; Rₜ=12.62 min (HRMS (ESI) calcd for C₂₂H₂₈N₃O₄ [M+H]⁺398.2080, found 398.2091), 12.89 min (HRMS (ESI) found 398.2089).

Pictet-Spengler reaction products of MABB3-Trp-Ile-OH (28) (FIG. 12c). Purity: >95%; Rₜ=15.20 min (HRMS (ESI) calcd for C₂₅H₃₄N₃O₄ [M+H]⁺440.2549, found 440.2553), 15.59 min (HRMS (ESI) found 440.2564).

Pictet-Spengler reaction products of MABB4-Trp-Ile-OH (29) (FIG. 12d). Purity: >95%; Rₜ=15.39 min (HRMS (ESI) calcd for C₂₈H₃₂N₃O₄ [M+H]⁺474.2393, found 474.2405), 15.76 min (HRMS (ESI) found 474.2406).

Pictet-Spengler reaction products MABB5-Trp-Ile-OH (30) (FIG. 12e). Purity: >95%; Rₜ=14.35 min (HRMS (ESI) calcd for C₂₇H₃₀N₃O₄ [M+H]⁺460.2236, found 460.2238), 14.53 min (HRMS (ESI) found 460.2245), 14.86 min (HRMS (ESI) found 460.2254).

Pictet-Spengler reaction products of MABB6-Trp-Ile-OH (31) (FIG. 12f). Purity: >95%; Rₜ=15.64 min (HRMS (ESI) calcd for C₂₇H₂₉N₃O₄ [M+H]⁺538.1341, found 538.1356, 15.75 min (HRMS (ESI) found 538.1366), 16.28 min (HRMS (ESI) found 538.1358).

Pictet-Spengler reaction products of MABB7-Trp-Ile-OH (32) (FIG. 12g). Purity: >95%; Rₜ=16.14 min. (HRMS (ESI) calcd for C₂₈H₂₉F₃N₃O₄ [M+H]⁺528.2110, found 528.2100), 16.50 min (HRMS (ESI) found 528.2153).

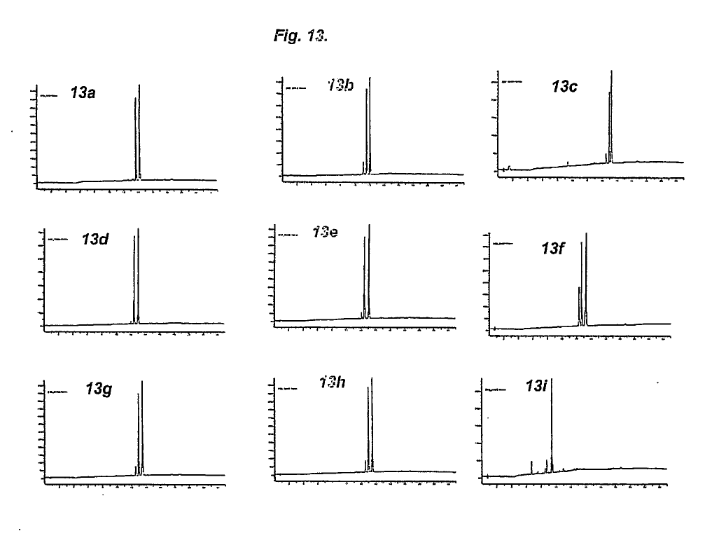

Possible Pictet-Spengler reaction products 2—variation of substituents on Trp. The following products may be obtained via the solid-phase Pictet-Spengler reactions of the present investigation. 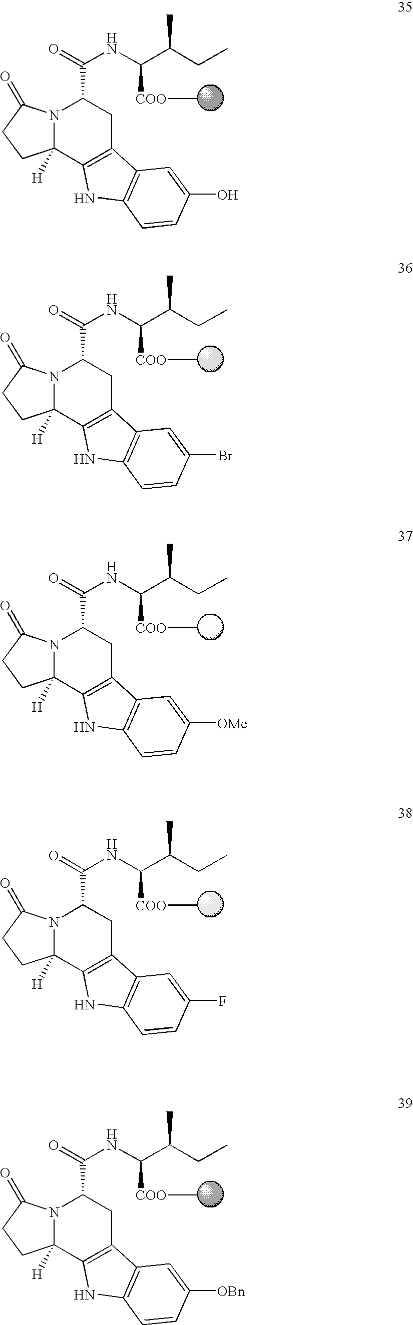 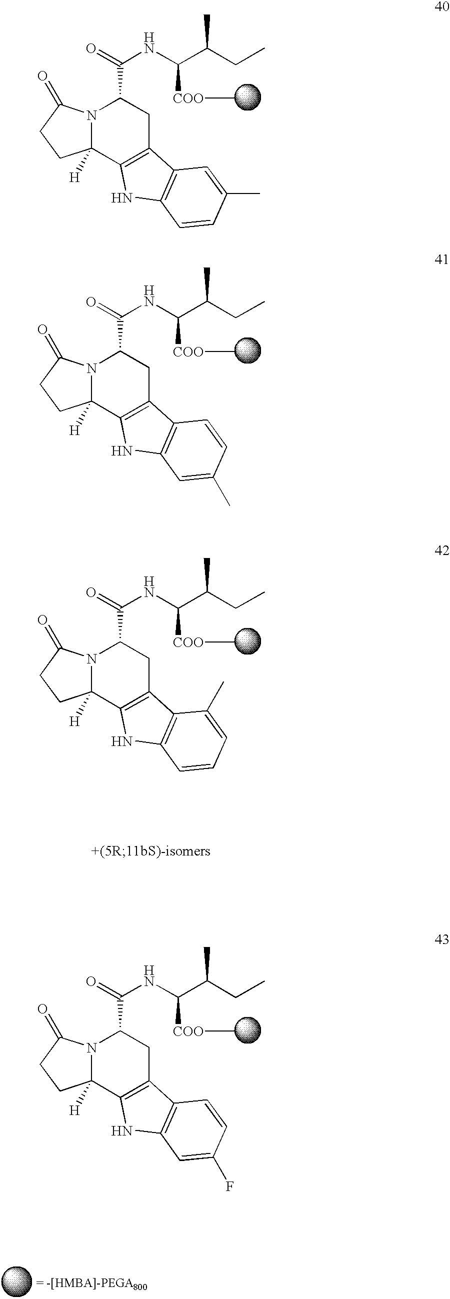
Representative Analytical HPLCs and MS for Pictet-Spengler Reaction Products 2 Released from Solid Phase as the Carboxylic Acid Derivatives (FIG. 13):

Pictet-Spengler reaction products of MABB1-(5-Br-(D/L)Trp-Ile-OH (36) (FIG. 13a). Purity: >95%; Rₜ=13.64 min (HRMS (ESI) calcd for C₂₁H₂₅BrN₃O₄ [M+H]⁺462.1028, found 462.0984), 14.19 min (HRMS (ESI) found 462.1051).

Pictet-Spengler reaction products of MABB1-(5-MeO-(D/L)Trp-Ile-OH (37) (FIG. 13b). Purity: >95%; Rₜ=11.56 min (HRMS (ESI) calcd for C₂₂H₂₈N₃O₅ [M+H]⁺414.2029, found 414.2026), 12.01 min (HRMS (ESI) found 414.2021).

Pictet-Spengler reaction products of MABB1-(5-BnO-(D/L)Trp-Ile-OH (39) (FIG. 13c). Purity: >95%; Rₜ=14.96 min (HRMS (ESI) calcd for C₂₈H₃₂N₃O₅ [M+H]⁺490.2342, found 490.2353), 15.19 min (HRMS (ESI) found 490.2340).

Pictet-Spengler reaction products of MABB1-(5-F-(D/L)Trp-Ile-OH (38) (FIG. 13d). Purity: >95%; Rₜ=12.38 min (HRMS (ESI) calcd for C₂₁H₂₅FN₃O₄ [M+H]⁺402.1829, found 402.1830), 12.98 min (HRMS (ESI) found 402.1855).

Pictet-Spengler reaction products of MABB1-(6-F-(D/L)Trp-Ile-OH (43) (FIG. 13e). Purity: >95%; Rₜ=12.46 min (HRMS (ESI) calcd for C₂₁H₂₅FN₃O₄ [M+H]⁺402.1829, found 402.1839), 13.06 min (HPMS (ESI) found 402.1828).

Pictet-Spengler reaction products of MABB1-(4-Me-(D/L)-Trp)-Ile-OH (4”) (FIG. 13f). Purity: >95%; Rₜ=12.64 min (HRMS (ESI) calcd for C₂₂H₂₈N₃O₄ [M+H]⁺398.2080, found 398.2081), 13.19 min (HRMS (ESI) found 398.2079).

Pictet-Spengler reaction products of MABB1-(5-Me-(D/L)Trp-Ile-OH (40) (FIG. 13g). Purity: >95%; Rₜ=12.98 min (HRMS (ESI) calcd for C₂₂H₂₈N₃O₄ [M+H]⁺398.2080, found 398.2091), 13.53 min (HRMS (ESI) found 398.2076).

Pictet-Spengler reaction products of MABB1-(6-Me-(D/L)Trp-Ile-OH (41) (FIG. 13h). Purity: >95%; Rₜ=12.94 min (HRMS (ESI) calcd for C₂₂H₂₈N₃O₄ [M+H]⁺398.2080, found 398.2095), 13.53 min (HRMS (ESI) found 398.2067).

Pictet-Spengler reaction products of MABB1-(5-OH)Trp-Ile-OH (35) (FIG. 13i). Purity: ˜80%; Rₜ=9.31 min; HRMS (ESI) calcd for C₂₁H₂₆N₃O₅ [M+H]⁺400.1872, found 400.1875.

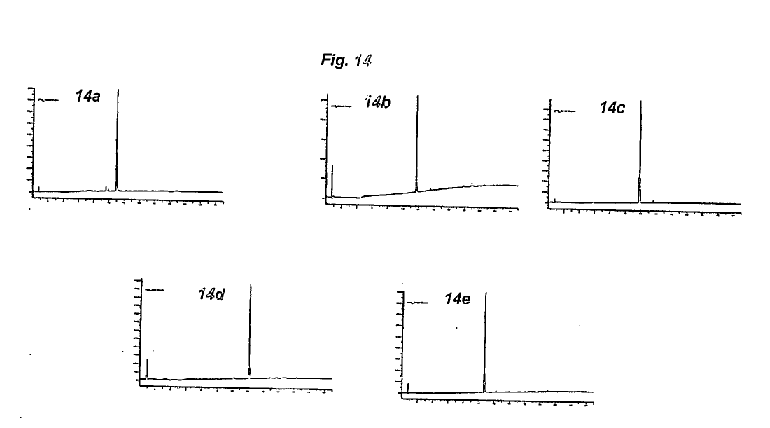

Possible Pictet-Spengler reaction products 3—variation of the aromatic side chain. The following products may be obtained via the solid-phase Pictet-Spengler reactions of the present invention. 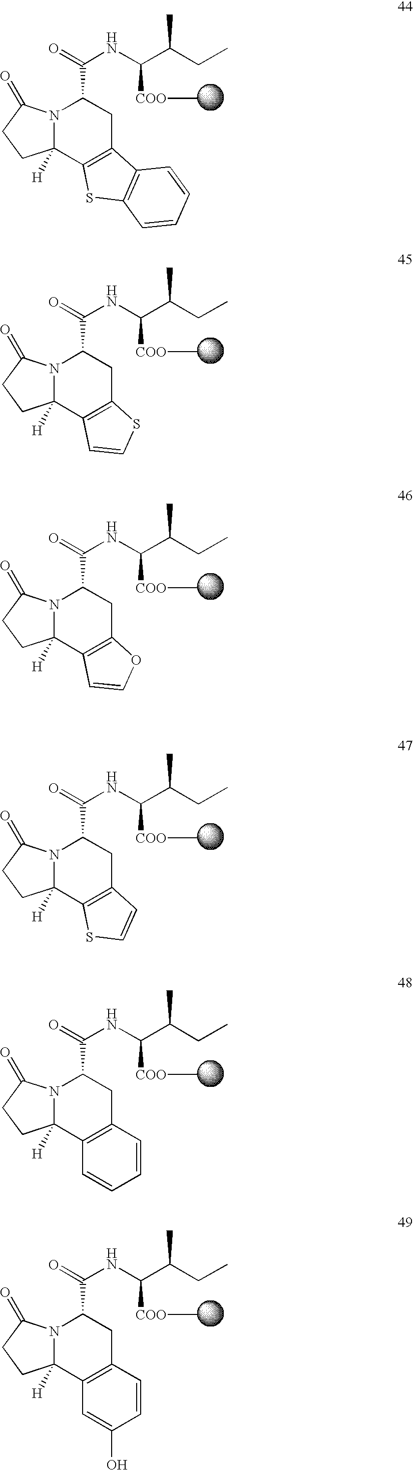 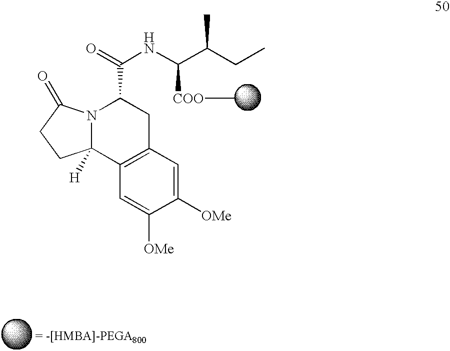
Representative Analytical HPLCs and MS for Pictet-Spengler Reaction Products 3 Released from Solid Phase as the Carboxylic Acid Derivatives (FIG. 14):

Pictet-Spengler reaction products of MABB1-(3-(2-furyl)Ala)-Ile-OH (46) (FIG. 14a). Purity: >95%; Rₜ=11.00 min; ¹H NMR (250 MHz, DMSO-d₆) δ 12.63 (bs, 1H), 8.17 (d, J=8.3 Hz, 1H), 7.52 (d, J=1.8 Hz, 1H), 6.39 (d, J=1.8 Hz, 1H), 5.12 (d, J=7.3 Hz, 1H), 4.87 (m, 1H), 4.11 (dd, J=8.3 Hz, J=6.5 Hz, 1H), (d, J=16.5 Hz, 1H), 2.88 (dd, J=16.5 Hz, J=8.0 Hz), 2.63-2.40 (m, 1H), 2.38-2.16 (m, 2H), 1.90-1.71 (m, 1H), 1.68-1.47 (m, 1H), 1.46-1.25 (m, 1H), 1.24-1.02 (m, 1H), 0.92-0.70 (m, 6H); HRMS (ESI) calcd for C₁₇H₂₃N₂O₅ [M+H]⁺335.1607, found 335.1627.

Pictet-Spengler reaction products of MABB1-(3-(2-thienyl)Ala)-Ile-OH (45) (FIG. 14b). Purity: >95%; Rₜ=11.59 min; ¹H NMR (250 MHz, DMSO-d₆) δ 12.61 (bs, 1H), 8.16 (d, J=8.5 Hz, 1H), 7.36 (d, J=5.5 Hz, 1H), 6.90 (d, J=5.5 Hz, 1H), 5.08 (d, J=6.5 Hz, 1H), 4.96 (dd [app. t], J=7.0 Hz, 1H), 4.10 (dd, J=8.0 Hz, J=6.3 Hz), 3.26 (d, J=16.3 Hz, 1H), 2.98 (dd, J=16.3 Hz, J=7.8 Hz), 2.65-2.46 (m, 2H), 2.35-2.18 (m, 1H), 1.90-1.69 (m, 1H), 1.68-1.45 (m, 1H), 1.42-1.20 (m, 1H), 1.20-1.00 (m, 1H), 0.92-0.65 (m, 6H); HPMS (ESI) calcd for C₁₇H₂₃N₂O₄S [M+H]⁺351.1378, found 351.1384.

Pictet-Spengler reaction products of MABB1-(3-(3-thlenyl)Ala)-Ile-OH (4:7) (FIG. 14c). Purity: >95%; Rₜ=11.78 min; ¹H NMR (250 MHz, DMSO-d₆) δ 12.61 (bs, 1H), 8.17 (d, J=8.5 Hz, 1H), 7.39 (d, J=5.0 Hz, 1H), 6.84 (d, J=5.0 Hz, 1H), 5.13 (dd [app. t], J=7.4 Hz, 1H), 5.03 (d, J=7.3 Hz, 1H), 4.10 (dd, J=8.3 Hz, J=6.5 Hz, 1H), 3.13 (d, J=16.5 Hz, 1H), 2.91-2.75 (m, 1H), 2.65-2.44 (m, 2H), 2.38-2.20 (m, 1H), 1.89-1.58 (m, 2H), 1.44-1.25 (m, 1H), 1.22-1.04 (m, 1H), 0.86-0.70 (m, 6H); HRMS (ESI) calcd for C₁₇H₂₃N₂O₄S [M+H]⁺351.1378, found 351-1383.

Pictet-Spengler reaction products of MABB1-(3-(3-benzothienyl)Ala)-Ile-OH (44) (FIG. 14d). Purity: >95%; Rₜ=14.09 min; ¹H NMR (250 MHz, DMSO-d₆) δ 12.59 (bs, 1H), 8.30 (d, J=8.3 Hz, 1H), 8.00-7.87 (m, 1H), 7.68-7.58 (m, 1H), 7.46-7.28 (m, 2H), 5.30-5.19 (m, 1H), (d, J=7.3 Hz), 4.09 (dd, J=8.5 Hz, J=6.8 Hz, 1H), 3.35 (d, J=16.5 Hz, 1H), 2.97 (ddd, J=16.5 Hz, J=8 Hz, J=2.4 Hz, 1H), 2.70-2.52 (m, 2H), 2.42-2.25 (m, 1H), 1.92-1.68 (m, 2H), 1.46-1.25 (m, 1H), 1.25-1.03 (m, 1H), 0.91-0.68 (m, 6H); HRMS (ESI) calcd for C₂₁H₂₅N₂O₄S [M+H]⁺401.1535, found 401.1543

Pictet-Spengler reaction products of MABB1-(3,4-dimethoxy-Phe)-Ile-OH (50) (FIG. 14e). Purity: >95%; Rₜ=10.56 min; ¹H NMR (250 MHz, DMSO-d₆) δ 12-61 (bs, 1H), 8.11 (d, J=8.3 Hz, 1H), 6.73 (d, J=4.5 Hz, 2H), 4.90 (dd [app. t], J=7.3 Hz, 1H), 4.80 (dd, J=6.8 Hz, J=4.0 Hz, 1H), 4.09 (dd, J=6.5 Hz, J=8.3 Hz, 1H), 3.72 (s, 6H), 3.07-2.81 (m, 2H), 2.74-2.58 (m, 1H), 2.58-2.40 (m, 1H), 2.32-2.15 (m, 1H), 1.88-1.61 (m, 2H), 1.44-1.25 (m, 1H), 1.23-1.00 (m, 1H), 0.84-0.65 (m, 6H); HRMS (ESI) calcd for C₂₁H₂₉N₂O₆ [M+H]⁺405.2025, found 425.2019.

### Example 4

Library Design and Synthesis

All Pictet-Spengler reaction methodology used in the present example has been developed and tested on the synthesis resin PEGA₆₀₀, (Meldal, M. Tetrahedron Lett. 1993, 33, 3077-3080) wherefore the analogous library resin PEGA₁₉₀₀ was chosen for the library synthesis. In order to screen for active compounds, the library was prepared following a “one-bead-two-compounds” strategy. This was accomplished by treating the amino-functionalized resin with a mixture of Fmoc-Gly-OH:Alloc-Gly-OH (10:1) activated by the TBTU procedure (Knorr, R.; Trzeciak, A.; Bannwarth, W.; Gillessen, D. Tetrahedron Lett. 1989, 30, 1927-1930) to provide orthogonal reaction sites for (a) split-and-mix library synthesis (via the Fmoc handle); and (b) attachment of an adhesion molecule (AM) (via the Fmoc handle). The library synthesis of Pictet-Spengler reaction precursor 1 was carried out according to standard Fmoc amino acid coupling protocols for solid-phase peptide synthesis (Scheme 1). The base labile HMBA (hydroxymethylbenzoic acid) linker was employed. Prior to attachment of HMBA to H₂N-Gly-PEGA₁₉₀₀ via the TBTU activation procedure, the Fmoc protecting group was removed by standard piperidine treatment. The HMBA linker pro vides a convenient cleavage site for quantitative release from the solid support via basic hydrolysis. Cleavage of product from a single bead was achieved by treating the bead with 0.1 M NaOH (aq) overnight, thus providing amounts of material sufficient for structure elucidation via QTOF ES-MSMS analysis. After splitting the resin portion into 10 different wells, the hydroxy handle of the linker was esterified by treatment with 10 MSNT-activated Fmoc amino acids (Fmoc-AA₁-OH), (Blankemeyer-Menge, B.; Nimtz, M.; Frank, R. Tetrahedron Lett. 1990, 31, 1701-1704) thus attaching the first amino acid residue of the peptidomimetic sequence. Subsequent analogous split-and-mix synthesis and 3 cycles of Fmoc deprotection/TBTU-mediated couplings of 10 Fmoc amino acids as the second amino acid residue (Fmoc-AA₂-OH), 15 Fmoc amino acids incorporating the reactive aromatic sidechain (Fmoc-AA₃-OH), and 7 masked aldehyde building blocks (R⁴-MABB-OH) (Table 1?), prepared as previously reported, (Groth, T.; Meldal, M. J. Comb. Chem. 2001, 3, 34-44, Nielsen, T. E.; Meldal, M. J. Org. Chem. 2004, 69, 3765-3773) afforded the Pictet-Spengler reaction precursor 1. In this coupling sequence, one fifth of the resin was withdrawn prior to the coupling of Fmoc-AA₂-OH (steps e and f), and remixed with the remaining resin from step g and forth. Ultimately, this afforded a library composed of tripeptoidal (n=0) and tetrapeptoidal (n=1) substructures. The Alloc protecting group of 1 was removed with Pd(PPh₃)₄, and subsequent TBTU coupling of Fmoc-Lys(Fmoc)-OH/Fmoc deprotection (×2) provided the amino handles for attachment of the adhesion molecule AM, which was accomplished via the TBTU activation procedure. The adhesion molecule was synthesized via standard solid-phase peptide synthesis, and purified by preparative HPLC prior to attachment to resin. To finalize the library synthesis, the resin 2 was treated with 10% TFA (aq), which simultaneously facilitated the intramolecular N-acyliminium Pictet-Spengler reaction and removal of the Boc-protecting groups in the side-chains of AA₁ (R¹) and AA₂ (R²). As a consequence of the structurally diverse aromatic heterocycles undergoing the intramolecular IV-acyliminium Pictet-Spengler reaction, the library is graphically represented by the six sublibraries (I-VI) below (Scheme 1). Theoretically, the library is composed by 11270 different compounds (32890 when all stereoisomers are counted).

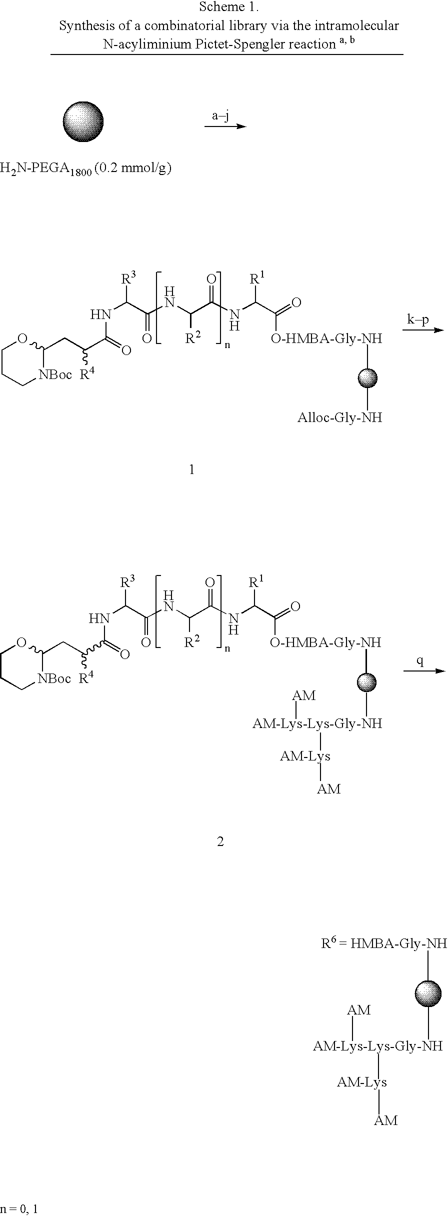

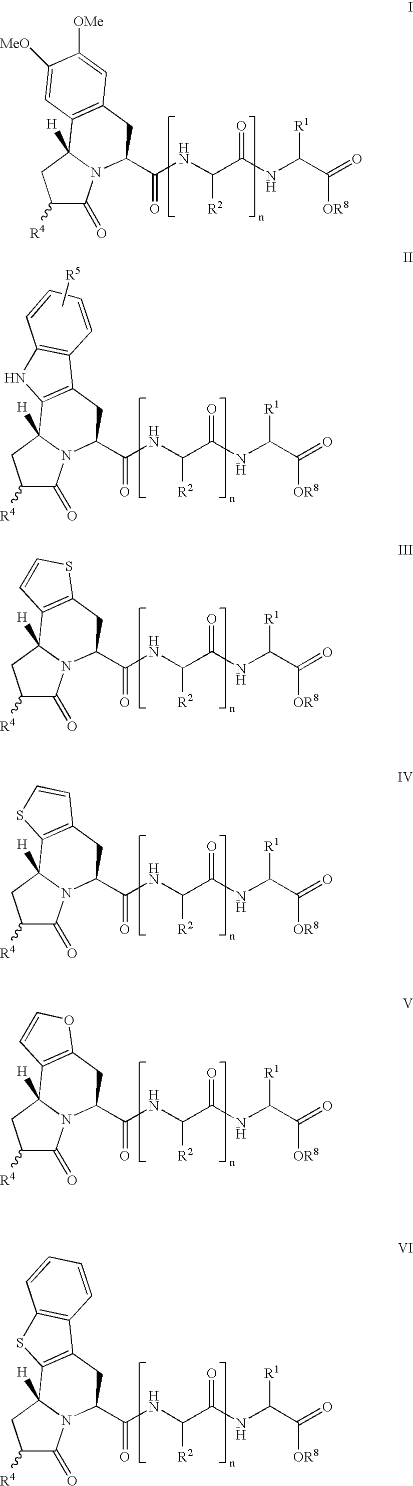

Reagents and conditions: (a) Fmoc-Gly-OH:Allor-Gly-OH (9:1), TBTU, NEM, DMF; (b) 20% piperidine (DMF); (c) HMBA, TBTU, NEM, DMF; (d) Fmoc-AA₁-OH, MSNT, Melm, CH₂Cl₂; (e) 20% piperidine (DMF); (f) Fmoc-AA₂-OH, TBTU, NEM, DMF; (g) 20% piperidine (DMF); (h) Fmoc-AA₃-OH, TBTU, NEM, DMF; (i) 20% piperidine (DMF); (j) R⁴-MABB-OH, TBTU, NEM, DMF; (k) Pd(PPh₃)₄ (CHCl₃:AcOH:NEM (925:50:25); (l) Fmoc-Lys(Fmoc)-OH, TBTU, NEM, DMF; (m) 20% piperidine (DMF); (n) Fmoc-Lys(Fmoc)-OH, TBTU, NEM, DMF; (o) 20% piperidine (DMF); (p) AM-OH, TBTU, NEM, DMF; (q) 10% TFA (aq); ^{a} Sublibraries I, III, IV, V and VI each consists of 700 different compounds (1300 when all stereoisomers are counted) with n=1, and 70 different compounds (130 when all stereoisomers are counted) with n=0; ^{b} Sublibrary II consists of 7000 different compounds (23400 when all stereoisomers are counted) with n=1, and 700 different compounds (2340 when all stereoisomers are counted) with n=0.

TABLE 1
Amino acids and building blocks for combinatorial library synthesis

| 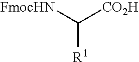 | 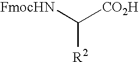 | 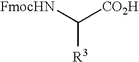 | 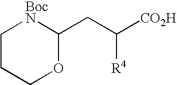 |
|---|---|---|---|
| Fmoc-AA₁-OH | Fmoc-AA₂-OH | Fmoc-AA₃-OH | rac-R⁴-MABB-OH |
| AA₁ | AA₂ | AA₃ (Sublibrary structure) | R⁴ |
| D-Phe | Phe | L-3,4-Dimethoxyphe (I) | H |
| D-Tyr(t-Bu) | Tyr(t-Bu) | Trp (II) | Me |
| D-Arg(Boc)₂ | Arg(Boc)₂ | D/L-(5-Br)Trp (II) | i-Bu |
| D-Lys(Boc) | Lys(Boc) | L-(5-OH)Trp (II) | Bn |
| D-His(Boc) | His(Boc) | D/L-(5-MeO)Trp (II) | Ph |
| D-Trp | Trp | D/L-(4-Me)Trp (II) | 4-Br-Ph |
| L-(1-Np)Ala | L-(1-Np)Ala | D/L-(5-Me)Trp (II) | 3-CF₃-Ph |
| L-Homophe | L-Homophe | D/L-(6-Me)Trp (II) | |
| L-(3-CN)Phe | L-(3-CN)Phe | D/L-(5-BnO)Trp (II) | |
| L-(4-CF₃)Phe | L-(4-CF₃)Phe | D/L-(5-F)Trp (II) | |
| | | D/L-(6-F)Trp (II) | |
| | | L-(2-Thi)Ala (III) | |
| | | L-(3-Thi)Ala | |
| | | L-(2-Fur)Ala (V) | |
| | | L-(3-BzThi)Ala (VI) | |

Experimental

General Methods. All solvents were of HPLC quality and stored over molecular sieves. Solid-phase organic combinatorial chemistry was routinely carried out using a 20-well peptide synthesizer equipped with sintered teflon filters (50 μm pores), teflon tubing, and valves, which allow suction to be applied below the wells. For all reactions on solid support, PEGA₁₉₀₀ resin (0.2 mmol/g, VersaMatrix A/S) was used. Prior to use, the resin was washed with methanol (×6), DMF (×6), and CH₂Cl₂ (×6). All commercially available reagents were used as received without further purification. Analysis of all solid-phase reactions was performed after cleaving the products as their free acids from the resin. A single bead was treated with 0.1 M aqueous NaOH (10 μL) in a 0.5 mL Eppendorf tube overnight, then diluted with CH₃CN (20 μL), before filtering the solution, thereby providing a sample for ES MSMS analysis on a MicroMass QTOF Global Ultima mass spectrometer (mobile phase 50% CH₃CN (aq), 0.1 μL/min).

Solid-phase synthesis of combinatorial library. Attachment of Fmoc-Gly-OH/Alloc-Gly-OH to the amino-functionalized PEGA₁₉₀₀ resin (1.00 g) was carried out by premixing Fmoc-Gly-OH (0.62 mmol, 185 mg):Alloc-Gly-OH (0.07 mmol, 9.9 mg) (9:1, 3.0 equiv in total), N-ethyl morpholine (HEM, 0.92 mmol, 106 mg, 4.0 equiv), and N-[(1H-benzotriazol-1-yl)-(dimethylamino)methylene]-N-methylmethanaminium tetrafluoroborate N-oxide (TBTU, 0.66 mmol, 213 mg, 0.88 equiv) for 5 min in DMF. The resulting solution was added to the DMF preswollen resin and allowed to react for 5 h, followed by washing with DMF (×6), and CH₂Cl₂ (×6). Completion of the reaction was monitored using the kaiser test. Prior to attachment of the HMBA linker via the procedure above, Fmoc-deprotection was accomplished with 20% piperidine in DMF, first for 2 min, and then for 18 min, followed by washing with DMF (×6). Coupling of the first amino acid (Fmoc-AA₁-OH) to the HMBA derivatized resin was accomplished by treating the freshly lyophilized resin, split in 20 (2×10) wells via dry CH₂Cl₂, with a mixture of the Fmoc-AA₁-OH (4.5 equiv), Melm (3.4 equiv), and MSNT (4.5 equiv) in CH₂Cl₂:THF (5:1) (Blankemeyer-Menge, B.; Nimtz, M.; Frank, R. Tetrahedron Lett. 1990, 31, 1701-1704). The coupling was carried out for 1 h. When split in 20 wells, each well was assumed to hold ca. 50 mg resin, and accordingly added reagents relative to 0.01 mmol of material on the solid phase. Excess reagents were removed with suction below each well, followed by washing with dry DMF (×1), and dry CH₂Cl₂ (×1), before repeating the MSNT coupling of Fmoc-AA₁-OH once. Subsequent split-and-mix peptide syntheses with Fmoc-AA₂-OH, Fmoc-AA₃-OH, and R⁴-MABB-OH, respectively, were accomplished following the coupling procedure described above for the attachment of Fmoc-Gly-OH (via TBTU and NEM in DMF) (Knorr, R.; Trzeciak, A.; Bannwarth, W.; Gillessen, D. Tetrahedron Lett. 1989, 30, 1927-1930) The usual washing protocol followed each coupling and deprotection step, and all couplings were checked via the Kaiser test. The Alloc group of 1 was removed by treating the resin with Pd(PPh₃)₄ (0.06 mmol, 69 mg, 3.0 equiv) in CHCl₃:AcOH:NEM (925:50:25) for 2 h. Washing was carried out with CHCl₃ (×6), a mixture of 5% sodium diethyldithiocarbamate trihydrate and 5% DIPEA in DMF (×2), and DMF (x 10). The free amino group of the resin (ca. 0.02 mmol) was coupled with Fmoc-Lys(Fmoc)-OH (0.06 mmol, 35 mg, 3.0 equiv.) via the TBTU activation procedure, using TBTU (0.058 mmol, 19 mg, 2.88 equiv), and NEM (0.08 mmol, 9 mg, 4.0 equiv). Following Fmoc-deprotection with 20% piperidine in DMF, first for 2 min, and then for 18 min, followed by washing with DMF (×6), the two newly liberated amino handles were coupled with Fmoc-Lys(Fmoc)-OH (0.12 mmol, 71 mg, 3.0 equiv pr amino handle) via the TBTU activation procedure, using TBTU (0.115 mmol, 37 mg, 2.88 equiv.) and NEM (0.16 mmol, 18 mg, 4.0 equiv). Another round of Fmoc-deprotection with 20% piperidine in DMF, first for 2 min, and then for 18 min, followed by washing with DMF (×6), provided four amino handles, which were coupled to the adhesion molecule AM-OH (0.24 mmol, Note: Insert mass mg, 3.0 equiv) via the TBTU activation procedure, using TBTU (0.23 mmol, 73 mg, 2.88 equip.) and MEM (0.32 mmol, 37 mg, 4.0 equiv). The resin was washed with DMF (x 6), and CH₂Cl₂ (×6), and lyophilized overnight. Finally, the library synthesis was finished by treating the resin with 10% TFA (aq) for 24 h, followed by washing with water (×6), DMF (×6), and CH₂Cl₂ (×6). The resin was lyophilized overnight, and kept in the freezer (−18° C.).

1. A precursor molecule of the formula
[MABB-(AA)ₙ-NuBB], wherein
MABB is a masked aldehyde building block of the formula:
[MA-L₁-AG-], wherein
MA is a masked aldehyde,
L₁ is an aryl or alkyl comprising x covalently linked atoms selected from the group consisting of C, N, O and S, wherein x is an integer in the range of 0 to 10, and wherein said aryl ring or alkyl chain may be substituted independently on each position, and wherein the atom most proximal to the CO group is a carbon atom,
AG is an acidic group capable of forming an amide bond,
AA is an amino acid of the formula —NHCR¹R²CO— and n is an integer in the range of 0 to 5,
NuBB is a nucleophile building block of the formula
[—NH-L₂-Nu-], wherein
—NH is an amino group that form the amide bond with AA or when n is 0 with AG,
L₂ is an alkyl comprising in the range of 1 to 4 covalently linked atoms selected from the group consisting of C, N, O and S, wherein each atom may be independently substituted,
Nu is a nucleophilic chemical entity comprising a n system, comprising an N, O or S atom or a chemical entity which is substituted with an N, O or S atom,
wherein NuBB is linked to (AA)ₙ or if n=0 to MABB via an amide bond and with the proviso, that when x=0, then n is at least 1,
and wherein the masked aldehyde may be transformed into a free aldehyde, and the free aldehyde group is capable of interacting intramolecularly with an amide group, thereby forming an N-acyliminium ion,
and wherein said N-acyliminium ion is capable of acting as an electrophile for intramolecular reaction with said nucleophilic chemical entity,
and wherein said precursor molecule is attached to a solid support.

2. The precursor according to claim 1, wherein the nucleophilic chemical entity is capable of participating in a Pictet-Spengler reaction, or a cyclization process involving a electronrich double or triple bond to form a new covalent bond, thereby forming a heterocyclic organic compound comprising at least 2 fused rings designated A and B, wherein ring A incorporates a carbonyl group and ring A and B shares at least one N atom.

3. (canceled)

4. The precursor according to claim 1, wherein the nucleophile chemical entity is selected from the group consisting of mono-, di- and trisubstituted aromatic and heteroaromatic rings, alkenes and alkynes comprising N, S or O.

5. The precursor according to claim 1, wherein the nucleophilic chemical entity is selected from the group consisting of arenes, benzothiophene, benzofuran, isoindoles, 1,3-azole, imidazole, thiazole, oxazole, 1,2-azole, pyrazole, isothiazole, isoxazole, isoxazoline, purine, indolizine, quinolizine, pyrrolizine, 1,2,3-triazole, 1,2,4-triazole, pyridine, quinoline, quinoline, isoquinoline, pyridazine, pyrimidine, pyrazine, pyrrole, indole, thiophene and furane.

6-12. (canceled)

13. The precursor according to claim 1, wherein the masked aldehyde is protected by an aldehyde protecting group selected from the group consisting of N-Boc N,O-acetals, di-Boc N,N-acetals, N-Boc N,S-acetals, di-O-acetals, di-S-acetals, S,O-acetals, F-moc and triakylsilyl.

14. (canceled)

15. The precursor according to claim 1, wherein the masked aldehyde has the formula —CO—X, wherein X is not —H.

16-25. (canceled)

26. The precursor according to claim 1, wherein L₁ is an alkyl chain.

27. (canceled)

28. The precursor according to claim 1, wherein L₁ has the structure 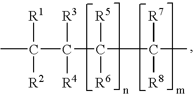
wherein n is 0 or 1 and M is 0 or 1 and wherein R¹, R², R³, R⁴, R⁵, R⁶ R⁷ and R⁸ independently may be selected from the group of functionalities consisting of H, hydroxy, alkoxy, aryloxy, acyloxy, thiol, alkylthio, arylthio, heteroarylthio, sulphonyl, sulphoxy, amino, alkylamino, dialkylamino, acylamino, diacylamino, alkoxycarbonylamino, amides, alkyl, branched alkyl, aryl, heteroaryl, nitro, cyano, halogeno, silyloxy, keto, heterocycles, fused ring systems, fused heterocycles and mixtures thereof, wherein each of the aforementioned may be substituted with one or more groups selected from the group consisting of —H, —OH, —SH, halogen, carboxyl, carbonyl, alkoxy, aryloxy, acyloxy, alkylthio, arylthio, heteroarylthio, sulphonyl, sulphoxy, amino, alkylamino, dialkylamino, acylamino, diacylamino, alkoxycarbonylamino, amides, alkyl, aryl, heteroaryl, nitro, cyano, halogeno, silyloxy, keto, heterocycles, fused ring systems, and fused heterocycles.

29-36. (canceled)

37. The precursor according to claim 1, wherein the acidic group is selected from the group consisting of —CO (carbonyl), —CS, —SO₂H, —SO₃H, —PO₂H and —PO₃H.

38. The precursor according to claim 1, wherein the amide group is selected from the group consisting of carbonyl amide, thiocarbonyl amide, phosphinic amide, phosphonic amide, sulfonic acid amide and sulfinic acid amide.

39. The precursor according to claim 1, wherein AA is an amino acid selected from the group consisting of naturally occurring amino acids, unnatural α-amino acids, and unnatural β-amino acids.

40. (canceled)

41. The precursor according to claim 1, wherein L₂ has the structure 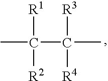
wherein R¹, R², R³ and R⁴ independently may be selected from the group consisting of H, hydroxy, alkoxy, aryloxy, acyloxy, thiol, alkylthio, arylthio, heteroarylthio, sulphonyl, sulphoxy, amino, alkylamino, dialkylamino, acylamino, diacylamino, alkoxycarbonylamino, amides, alkyl, branched alkyl, aryl, heteroaryl, nitro, cyano, halogeno, silyloxy, keto, heterocycles, fused ring systems, fused heterocycles and mixtures thereof, wherein each of the aforementioned may be substituted with one or more groups selected from the group consisting of —H, —OH, —SH, halogen, carboxyl, carbonyl, alkoxy, aryloxy, acyloxy, alkylthio, arylthio, heteroarylthio, sulphonyl, sulphoxy, amino, alkylamino, dialkylamino, acylamino, diacylamino, alkoxycarbonylamino, alkyl, branched alkyl, aryl, heteroaryl, nitro, cyano, halogeno, silyloxy, keto, heterocycles, fused ring systems, and fused heterocycles.

42-56. (canceled)

57. The precursor according to claim 1, wherein the solid support is a resin bead comprising polyethylene glycol (PEG).

58. (canceled)

59. A method of preparing a precursor molecule according to claim 1, comprising the steps of
i) Providing a masked aldehyde building block (MABB) of the formula:
[MA-L₁-AG₂], wherein
MA is a masked aldehyde protected by an aldehyde protecting group,
L₁ is an aryl or alkyl comprising x covalently linked atoms selected from the group consisting of C, N, S and O that may be substituted independently on each position, wherein x is an integer in the range of 1 to 10 wherein the atom most proximal to the CO group is a carbon atom,
AG₂ is an acidic group capable of reacting with an amino group to form an amide,
ii) Providing a molecule of the structure [-(AA)ₙ-NuBB], wherein AA is an amino acid and n is an integer in the range of 0 to 5, NuBB is a nucleophile building block of the formula
[—NH-L₂-Nu-], wherein
—NH— is the amino group that form an amide bond with AA or when n is 0 —NH— is an —NH₂ group capable of forming an amide with AG₂,
L₂ is an alkyl comprising in the range of 1 to 4 covalently linked atoms selected from the group consisting of C, N, O and S, wherein each atom may be independently substituted,
Nu is a nucleophilic chemical entity comprising a π system comprising an N, O or S atom or a chemical entity which is substituted with an N, O or S atom,
wherein (AA)ₙ is linked to NuBB via an amide bond,
and wherein said molecule is covalently attached to a solid support
iii) Reacting said MABB with said molecule, thereby forming an amide bond between said MABB and said molecule
iv) Thereby obtaining a precursor molecule.

60-61. (canceled)

62. The method according to claim 59, wherein said nucleophilic chemical entity is selected from the group consisting of chemical entities comprising a functional group selected from the group consisting of —NHR, —NH2, Alkyl-SH, Aryl-SH, Alkyl-OH, Aryl-OH, mono-, di-, and trisubstituted aromatic and heteroaromatic rings, alkenes and alkynes.

63-66. (canceled)

67. The method according to claim 59, wherein the masked aldehyde is protected be an aldehyde protecting group is selected from the group consisting of N-Boc N,O-acetals, di-Boc N,N-acetals, N-Boc N,S-acetals, N—F-moc N,O-acetals, di-F-moc N,N-acetals, N—F-moc N,S-acetals, N-triakylsilyl N,O-acetals, di-triakylsilyl N,N-acetals, N-triakylsilyl N,S-acetals, di-O-acetals, di-S-acetals and S,O-acetals.

68. (canceled)

69. The method according to claim 59, wherein the protected aldehyde has the formula —CO—X, wherein X is not —H.

70-71. (canceled)

72. The method according to claim 59, wherein L₁ is an alkyl chain.

73-74. (canceled)

75. The method according to claim 59, wherein AG₂ is selected from the group consisting of carboxylic acid, carboxylic acid halogenid, sulfonyl halogenid and phosphonyl halogenid.

76. The method according to claim 59, wherein the amide is selected from the group consisting of carbonyl amide, thiocarbonyl amide, phosphinic amide, phosphonic amide, sulfonic acid amide and sulfinic acid amide.

77. The method according to claim 59, wherein AA is an amino acid selected from the group consisting of naturally occurring amino acids, unnatural α-amino acids, and unnatural β-amino acids.

78. (canceled)

79. The method according to claim 59, wherein L₂ has the structure 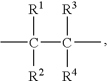
wherein R¹, R², R³ and R⁴ independently may be selected from the group consisting of H, hydroxy, alkoxy, aryloxy, acyloxy, thiol, alkylthio, arylthio, heteroarylthio, sulphonyl, sulphoxy, amino, alkylamino, dialkylamino, acylamino, diacylamino, alkoxycarbonylamino, amides, alkyl, branched alkyl, aryl, heteroaryl, nitro, cyano, halogeno, silyloxy, keto, heterocycles, fused ring systems, fused heterocycles and mixtures thereof, wherein each of the aforementioned may be substituted with one or more groups selected from the group consisting of —H, —OH, —SH, halogen, carboxyl, carbonyl, alkoxy, aryloxy, acyloxy, alkylthio, arylthio, heteroarylthio, sulphonyl, sulphoxy, amino, alkylamino, dialkylamino, acylamino, diacylamino, alkoxycarbonylamino, alkyl, branched alkyl, aryl, heteroaryl, nitro, cyano, halogeno, silyloxy, keto, heterocycles, fused ring systems, and fused heterocycles.

80-81. (canceled)

82. A method of preparing a heterocyclic organic compound comprising at least 2 fused rings designated A and B, wherein ring A incorporates a carbonyl group and ring A and B shares at least one N atom, said method comprising the steps of
a) Providing a precursor molecule of the formula:
[MABB-(AA)ₙ-NuBB], wherein
MABB is a masked aldehyde building block of the formula:
[MA-L₁-AG-], wherein
MA is a masked aldehyde,
L₁ is an aryl or alkyl comprising x covalently linked atoms selected from the group consisting of C, N, O and S, wherein x is an integer in the range of 0 to 10, and wherein said aryl ring or alkyl chain may be substituted independently on each position, and wherein the atom most proximal to the CO group is a carbon atom,
AG is an acidic group capable of forming an amide bond,
AA is an amino acid of the formula —NHCR¹R²CO— and n is an integer in the range of 0 to 5,
NuBB is a nucleophile building block of the formula
[—NH-L₂-Nu-], wherein
—NH is an amino group that form an amide bond with AA or when n is 0 with AG,
L₂ is an alkyl comprising in the range of 1 to 4 covalently linked atoms selected from the group consisting of C, N, O and S, wherein each atom may be independently substituted,
Nu is a nucleophilic chemical entity comprising a z system,
wherein NuBB is linked to (AA)ₙ or if n=0 to MABB via an amide bond and with the proviso, that when x=0, then n is at least 1,
and wherein the masked aldehyde may be transformed into a free aldehyde, and the free aldehyde group is capable of interacting intramolecularly with an amide group, thereby forming an N-acyliminium ion,
and wherein said N-acyliminium ion is capable of acting as an electrophile for intramolecular reaction with said nucleophilic chemical entity,
and wherein said precursor molecule is attached to a solid support,
b) Transforming the masked aldehyde into a free aldehyde
c) Reacting said free aldehyde with an amide group within said precursor molecule, thereby obtaining an N-acyliminium ion, wherein said N-acyliminium ion is capable of acting as an electrophile
c) Performing an intramolecular nucleophilic reaction involving the N-acyliminium ion and the nucleophilic chemical entity forming a new covalent bond, thereby obtaining said cyclic organic compound.

83. The method according to claim 82, wherein the precursor molecule is of the formula
[MABB-(AA)ₙ-NuBB], wherein
MABB is a masked aldehyde building block of the formula:
[MA-L₁-AG-], wherein
MA is a masked aldehyde
L₁ is an aryl or alkyl comprising x covalently linked atoms selected from the group consisting of C, N, O and S, wherein x is an integer in the range of 0 to 10, and wherein said aryl ring or alkyl chain may be substituted independently on each position, and wherein the atom most proximal to the CO group is a carbon atom
AG is an acidic group capable of forming an amide bond,
AA is an amino acid of the formula —NHCR¹R²CO— and n is an integer in the range of 0 to 5.
NuBB is a nucleophile building block of the formula
[—NH-L₂-Nu-], wherein
—NH is an amino group that form the amide bond with AA or when n is 0 with AG
L₂ is an alkyl comprising in the range of 1 to 4 covalently linked atoms selected from the group consisting of C, N, O and S, wherein each atom may be independently substituted,
Nu is a nucleophilic chemical entity comprising a π system comprising an N, O or S atom or a chemical entity which is substituted with an N, O or S atom,
wherein NuBB is linked to (AA)ₙ or if n=0 to MABB via an amide bond and with the proviso, that when x=0, then n is at least 1,
and wherein the masked aldehyde may be transformed into a free aldehyde, and the free aldehyde group is capable of interacting intramolecularly with an amide group, thereby forming an N-acyliminium ion,
and wherein said N-acyliminium ion is capable of acting as an electrophile for intramolecular reaction with said nucleophilic chemical entity,
and wherein said precursor molecule is attached to a solid support.

84. The method according to claim 82, wherein the intramolecular nucleophilic reaction is a Pictet Spengler reaction.

85. The method according to claim 82, wherein transforming the masked aldehyde into a free aldehyde comprises acid treatment, alkaline treatment, fluoridolysis or hydrogenolysis.

86-91. (canceled)

92. The method according to claim 82, wherein said heterocyclic organic compound comprises 3 fused rings.

93-94. (canceled)

95. The method according to claim 92, wherein the heterocyclic organic compound comprises one ring derived from the nucleophile chemical entity.

96. (canceled)

97. The method according to claim 82, wherein ring A is a lactam.

98-106. (canceled)

107. A method of preparing a heterocyclic organic compound comprising at least 2 fused rings designated A and B, wherein said method comprises the steps of
a) performing the method according to claim 82, thereby obtaining a heterocyclic organic compound comprising at least one carbonyl group; and
b) deoxygenating the heterocyclic organic compound comprising at least one carbonyl group;
c) thereby obtaining a heterocyclic organic compound comprising at least two fused rings.

108. A method of preparing a library comprising at least 2 different cyclic organic compounds each comprising at least 2 fused rings designated A and B, wherein ring A is substituted with a carbonyl group and ring A and B shares at least one N atom, said method comprising the steps of
a) Providing at least 2 different precursor molecules of the formula:
[MABB-(AA)ₙ-NuBB], wherein
MABB is a masked aldehyde building block of the formula:
[MA-L₁-AG-], wherein
MA is a masked aldehyde,
L₁ is an aryl or alkyl comprising x covalently linked atoms selected from the group consisting of C, N, O and S, wherein x is an integer in the range of 0 to 10, and wherein said aryl ring or alkyl chain may be substituted independently on each position, and wherein the atom most proximal to the CO group is a carbon atom,
AG is an acidic group capable of forming an amide bond,
AA is an amino acid of the formula —NHCR¹R²CO— and n is an integer in the range of 0 to 5,
NuBB is a nucleophile building block of the formula
[—NH-L₂-Nu-], wherein
—NH is an amino group that form an amide bond with AA or when n is 0 with AG,
L₂ is an alkyl comprising in the range of 1 to 4 covalently linked atoms selected from the group consisting of C, N, O and S, wherein each atom may be independently substituted,
Nu is a nucleophilic chemical entity comprising a π system,
wherein NuBB is linked to (AA)ₙ or if n=0 to MABB via an amide bond and with the proviso, that when x=0, then n is at least 1,
and wherein the masked aldehyde may be transformed into a free aldehyde, and the free aldehyde group is capable of interacting intramolecularly with an amide group, thereby forming an N-acyliminium ion,
and wherein said N-acyliminium ion is capable of acting as an electrophile for intramolecular reaction with said nucleophilic chemical entity,
and wherein said precursor molecule is attached to a solid support,
b) performing the method according to claim 82 for each of said precursor molecules
c) thereby obtaining a library comprising at least 2 different cyclic organic compounds.

109. The method according to claim 108, wherein the precursor molecule is a precursor molecule of the formula
[MABB-(AA)ₙ-NuBB], wherein
MABB is a masked aldehyde building block of the formula:
[MA-L₁-AG-], wherein
MA is a masked aldehyde,
L₁ is an aryl or alkyl comprising x covalently linked atoms selected from the group consisting of C, N, O and S, wherein x is an integer in the range of 0 to 10, and wherein said aryl ring or alkyl chain may be substituted independently on each position, and wherein the atom most proximal to the CO group is a carbon atom,
AG is an acidic group capable of forming an amide bond,
AA is an amino acid of the formula —NHCR¹R²CO— and n is an integer in the range of 0 to 5,
NuBB is a nucleophile building block of the formula
[—NH-L₂-Nu-], wherein
—NH is an amino group that form the amide bond with AA or when n is 0 with AG,
L₂ is an alkyl comprising in the range of 1 to 4 covalently linked atoms selected from the group consisting of C, N, O and S, wherein each atom may be independently substituted,
Nu is a nucleophilic chemical entity comprising a π system, comprising an N, O or S atom or a chemical entity which is substituted with an N, O or S atom,
wherein NuBB is linked to (AA)ₙ or if n=0 to MABB via an amide bond and with the proviso, that when x=0, then n is at least 1,
and wherein the masked aldehyde may be transformed into a free aldehyde, and the free aldehyde group is capable of interacting intramolecularly with an amide group, thereby forming an N-acyliminium ion,
and wherein said N-acyliminium ion is capable of acting as an electrophile for intramolecular reaction with said nucleophilic chemical entity,
and wherein said precursor molecule is attached to a solid support.

110-113. (canceled)

114. Library of heterocyclic compounds, wherein said compounds comprises at least 2 fused rings designated A and B, wherein ring A is substituted with a carbonyl group and ring A and B shares at least one N atom, and wherein a sequence of one or more amino acids is covalently linked to said fused rings, wherein said library is prepared by the method according to claim 108, and wherein said heterocyclic compounds are linked to a solid support.

115. (canceled)

116. The library according to claim 114, wherein the library comprises or consists of compounds of the general formula:

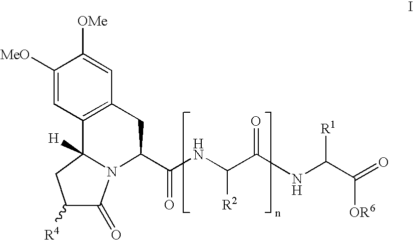

117. The library according to claim 114, wherein the library comprises or consists of compounds of the general formula:

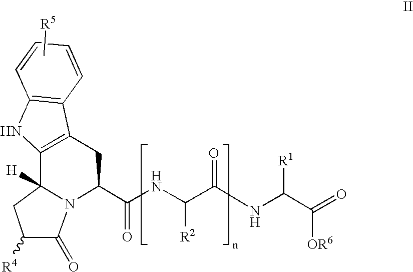

118. The library according to claim 114, wherein the library comprises or consists of compounds of the general formula:

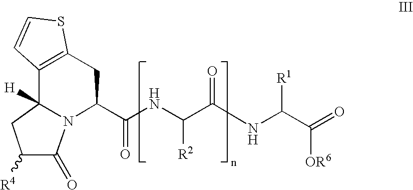

119. The library according to claim 114, wherein the library comprises or consists of compounds of the general formula:

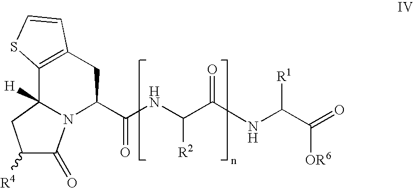

120. The library according to claim 114, wherein the library comprises or consists of compounds of the general formula:

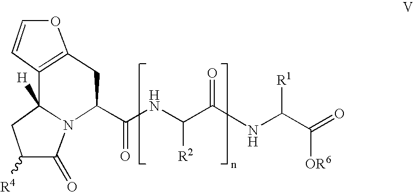

121. The library according to claim 114, wherein the library comprises or consists of compounds of the general formula:

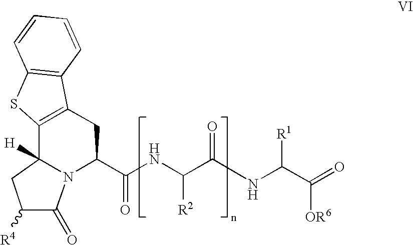

122-124. (canceled)

125. A method of identifying a heterocyclic organic compound capable of associating with a cell surface molecule naturally expressed on the surface of a cell, said method comprising the steps of
i) Providing the library according to claim 114,
ii) Providing a composition comprising said cell surface molecule,
iii) Incubating said library with said composition
iv) Identifying heterocyclic compounds of said library capable of specifically associating with said cell surface molecule.

126-133. (canceled)

134. A method of treatment of a clinical condition comprising administering a heterocyclic organic compound identified according to the method according to claim 125 to an individual in need thereof.

135-138. (canceled)

139. A method of identifying a heterocyclic organic compound capable of acting as a protease inhibitor, said method comprising the steps of
i) Providing the library according to claim 114,
ii) Providing a peptide substrate of a protease,
iii) Providing a protease capable of cleaving said substrate
iv) Incubating said library with said peptide substrate and said protease
v) Identifying heterocyclic compounds of said library capable of specifically inhibiting cleavage of said substrate.

140-143. (canceled)
